(19) United States
(12) Patent Application Publication
(10) Pub. No.: US 2015/0121868 A1
(43) Pub. Date: May 7, 2015

(54) STRUCTURAL ARRANGEMENT FOR A DOWN-HOLE TURBINE

(71) Applicants: Kenneth W. Fryrear, Midland, TX (US); Michael Pierce, Erie, CO (US); Dave Marshall, Dallas, TX (US); Frederick E. Becker, Reading, MA (US); Sharon Wight, Hartland, VT (US); Jamin Bitter, Lehi, UT (US); Alexander Gofer, Hanover, NH (US)

(72) Inventors: Kenneth W. Fryrear, Midland, TX (US); Michael Pierce, Erie, CO (US); Dave Marshall, Dallas, TX (US); Frederick E. Becker, Reading, MA (US); Sharon Wight, Hartland, VT (US); Jamin Bitter, Lehi, UT (US); Alexander Gofer, Hanover, NH (US)

(73) Assignee: GEOTEK ENERGY, LLC, Frisco, TX (US)

(21) Appl. No.: 14/352,013

(22) PCT Filed: Oct. 19, 2012
(86) PCT No.: PCT/US12/61165

§ 371 Date: Apr. 15, 2014

Related U.S. Application Data
(60) Provisional application No. 61/550,331, filed on Oct. 21, 2011.
(60) Provisional application No. 61/585,218, filed on Jan. 10, 2012.

(51) Int. Cl. F03G 7/04

(52) U.S. Cl. CPC F03G 7/04
USPC 60/641.4

(57) ABSTRACT

In a geothermal power system that includes a turbine generator, a down-hole heat exchanger, and a turbine pump assembly, various arrangements for the turbine pump assembly are described. Those arrangements address considerations related to the design of the down-hole turbine pump. In such a system, the turbine generator receives a high pressure working fluid from the down-hole system to drive a generator. The turbine generator is in fluid communication with the down-hole heat exchanger and with the turbine portion of a removably disposed down-hole turbine pump assembly. The pump portion of the down-hole turbine pump assembly is in fluid communication with the down-hole heat exchanger and a source of geothermal fluid.

### CROSS REFERENCE TO RELATED APPLICATIONS

This application claims the benefit of priority of U.S. Provisional Application No. 61/550,331 filed on Oct. 21, 2011, and U.S. Provisional Application No. 61/585,218 filed on Jan. 10, 2012. The entire disclosures of these earlier applications are incorporated herein by reference.

### BACKGROUND

1. Field of the Invention

This application relates generally to subsurface equipment for geothermal power systems and more particularly to a down-hole turbine.

2. Description of the Related Art

A down-hole turbine pump unit or assembly is described in U.S. Pat. No. 4,388,807 (Matthews). In Matthews a geothermal power plant is described where the down-hole turbine is used to power a pump within a geothermal well. In Matthews, the down-hole turbine is driven by a vaporized working fluid (such as a halocarbon) to drive the pump, which pumps a geothermal fluid to the surface. The elevated geothermal fluid is used to vaporize the working fluid. The working fluid returning to the surface from the down-hole turbine is used to drive a turbine generator at the surface to produce electrical power.

### SUMMARY OF THE INVENTION

A need exists for a robust down-hole turbine adapted for a down-hole operating environment.

In one aspect of the invention, a geothermal power system is provided, which includes a turbine-generator, a down-hole heat exchanger, and a turbine-pump assembly. The turbine-generator is structured to receive an organic working fluid and to drive an electric generator. The down-hole heat exchanger is structured to transfer heat from an upwardly directed geothermal fluid to the working fluid. The turbine-pump assembly includes a turbine coupled to a geothermal fluid pump. The turbine-pump assembly is removably disposed down-hole in a well. The geothermal fluid pump is in fluid communication with the down-hole heat exchanger and a source of geothermal fluid. The turbine is in fluid communication with the down-hole heat exchanger and the turbine-generator so as to receive the working fluid from the turbine-generator through a conduit system in the well and to return the working fluid to the turbine-generator through the conduit system. The turbine includes a turbine casing, a turbine shaft rotatably supported by the turbine casing and coaxial with the well, and a rotor coupled to the shaft. The turbine rotor is structured to receive the working fluid from the heat exchanger and to redirect the working fluid to flow in opposed axial directions. The turbine also includes bearings supporting the turbine shaft, the bearings being disposed between the shaft and the turbine casing, and the bearings being lubricated by the working fluid. At least one circumferential inlet is formed through the turbine casing, with the inlet being constructed to direct working fluid to the rotor. The turbine shaft is constructed to direct the working fluid redirected by the rotor in an outlet direction towards the turbine-generator.

In another aspect of the invention, an expander pumping unit for a geothermal power system is provided. The expander pumping unit includes a turbine disposed down-hole in a geothermal well and a geothermal fluid pump operatively coupled to the turbine. The turbine is constructed to receive a working fluid flowing downward from a terrestrial surface region and to expand the working fluid to the terrestrial surface region. The geothermal fluid pump pumps geothermal fluid upward from a source of geothermal fluid. The turbine includes a turbine casing, a turbine shaft rotatably coupled to the turbine casing, and bearings between the turbine casing and the turbine shaft for supporting the turbine shaft in the turbine casing. The bearings are lubricated by the working fluid. The turbine also includes a turbine rotor coupled to the turbine shaft. At least one circumferential inlet is formed around the turbine rotor and is constructed for delivering the working fluid to the turbine rotor. The rotor is constructed to redirect the working fluid received from the inlet in at least two opposed axial directions. Moreover, the turbine shaft is constructed to direct the working fluid redirected by the rotor in an outlet direction toward the terrestrial surface region.

In another aspect of the invention a turbine is provided for use down-hole in a geothermal well of a geothermal power system. The turbine includes a turbine casing, a turbine shaft rotatably coupled to the turbine casing, and bearings between the turbine casing and the turbine shaft for supporting the turbine shaft in the turbine casing. The bearings are lubricated by an organic working fluid. The turbine also includes a turbine rotor coupled to the turbine shaft, and at least one circumferential inlet formed around the turbine rotor and constructed for delivering the working fluid to the turbine rotor. The rotor is constructed to redirect the working fluid received from the inlet in at least two opposed axial directions. The turbine shaft is constructed to direct the working fluid redirected by the rotor axially in an outlet direction toward a terrestrial region above the turbine.

This brief summary has been provided so that the nature of the invention may be understood quickly. A more complete understanding of the invention can be obtained by reference to the following detailed description in connection with the attached drawings.

### BRIEF DESCRIPTION OF THE DRAWINGS

FIG. 1A is a schematic diagram of a geothermal power system in accordance with an example embodiment of the invention.

FIG. 1B is a more detailed schematic diagram of the geothermal power system shown in FIG. 1A.

FIG. 1C is a process flow diagram of a power system in accordance with an example embodiment of the invention.

FIGS. 2 and 3 show states of the working fluid in a working fluid loop in a power system in accordance with an example embodiment of the invention.

FIGS. 4 and 5 show a sectional view of a subsurface portion of a well constructed in accordance with an embodiment of the invention.

FIG. 6 shows a sectional view of a subsurface portion of a well constructed in accordance with an embodiment of the invention.

FIG. 7A shows a cutaway view of a geothermal fluid pump in accordance with an embodiment of the invention.

FIG. 7B shows a sectional view through the geothermal fluid pump of FIG. 7A.

FIG. 8A shows a sectional view of a down-hole turbine in accordance with an embodiment of the invention.

FIG. 8B shows a side elevational view of the down-hole turbine shown in FIG. 8A.

FIG. 8C shows an exploded view of a portion of the down-hole turbine shown in FIG. 8A.

FIG. 9 schematically shows a magnetic coupling in accordance with an embodiment of the invention.

FIG. 10 schematically shows another magnetic coupling in accordance with an embodiment of the invention.

FIG. 11 shows a sectional view of a down-hole turbine in accordance with an embodiment of the invention.

FIG. 12 shows a sectional view of a down-hole turbine in accordance with an embodiment of the invention.

FIG. 13 shows a sectional view of a down-hole turbine in accordance with an embodiment of the invention.

FIG. 14 shows a sectional view of a down-hole turbine having two radial inlets and two balance chambers in accordance with an embodiment of the invention.

FIG. 15 shows a sectional view of a portion of a down-hole turbine having two radial inlets and two balance chambers in accordance with an embodiment of the invention.

FIG. 16 shows a sectional view of a down-hole turbine having two radial inlets and one balance chamber in accordance with an embodiment of the invention.

FIG. 17 shows a sectional view of a portion of a down-hole turbine having two radial inlets and one balance chamber in accordance with an embodiment of the invention.

FIG. 18 shows a sectional view of a down-hole turbine having one radial inlet and two balance chambers in accordance with an embodiment of the invention.

FIG. 19 shows a sectional view of a down-hole turbine having an axial inlet configuration and two balance chambers in accordance with an embodiment of the invention.

FIG. 20 shows an exploded view of an upper portion of the down-hole turbine of FIG. 19.

### DETAILED DESCRIPTION

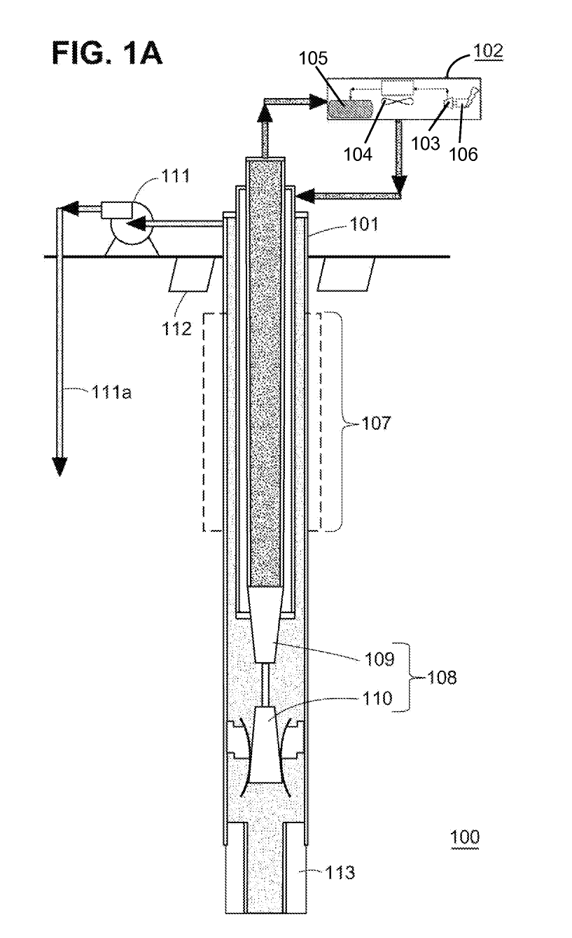

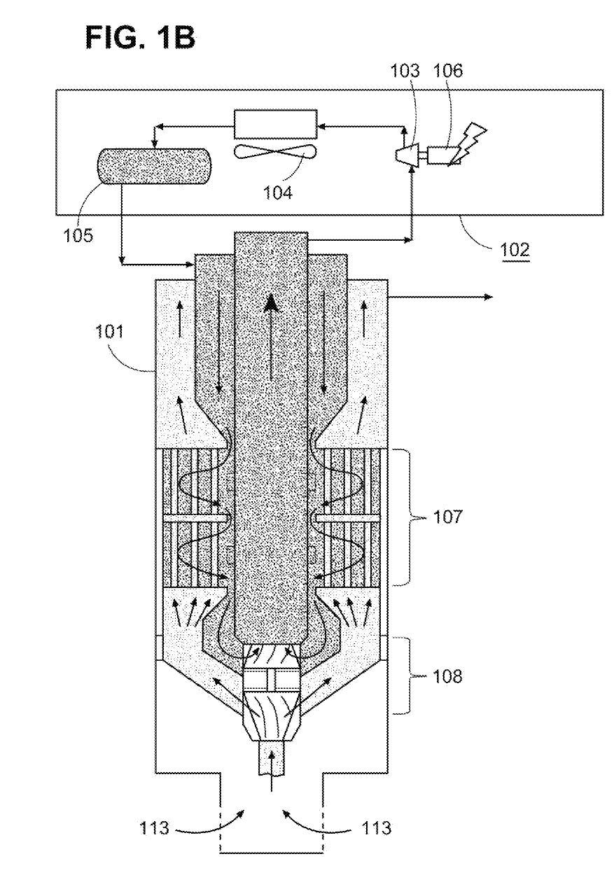

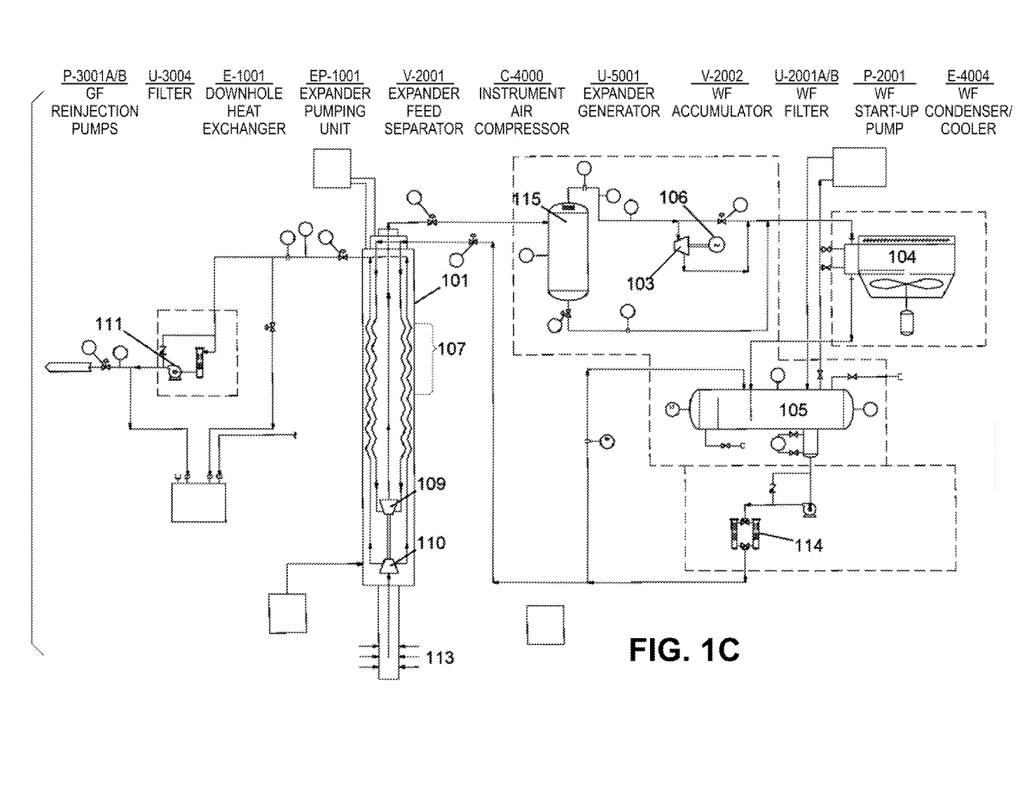

FIG. 1A is a schematic diagram of a geothermal power system 100 in accordance with an example embodiment of the invention. The system 100 includes components located above and below ground 112 in a well 101. Above the surface of the well 101 the system 100 includes a power plant 102. As shown in FIG. 1B, the power plant 102 includes a generating turbine 103 in fluid communication with a condenser 104 and an accumulator 105. The generating turbine 103 drives an electric generator 106. As shown in FIG. 1A, below the surface 112 of the well 101 the system 100 also includes a down-hole heat exchanger 107 and an expander pump unit 108 surrounded by the well 101. An example of an arrangement of the well 101 and the subsurface equipment in the well is described in U.S. patent application Ser. No. 12/510,978, entitled Completion System for Subsurface Equipment, the entire contents of which are incorporated herein by reference.

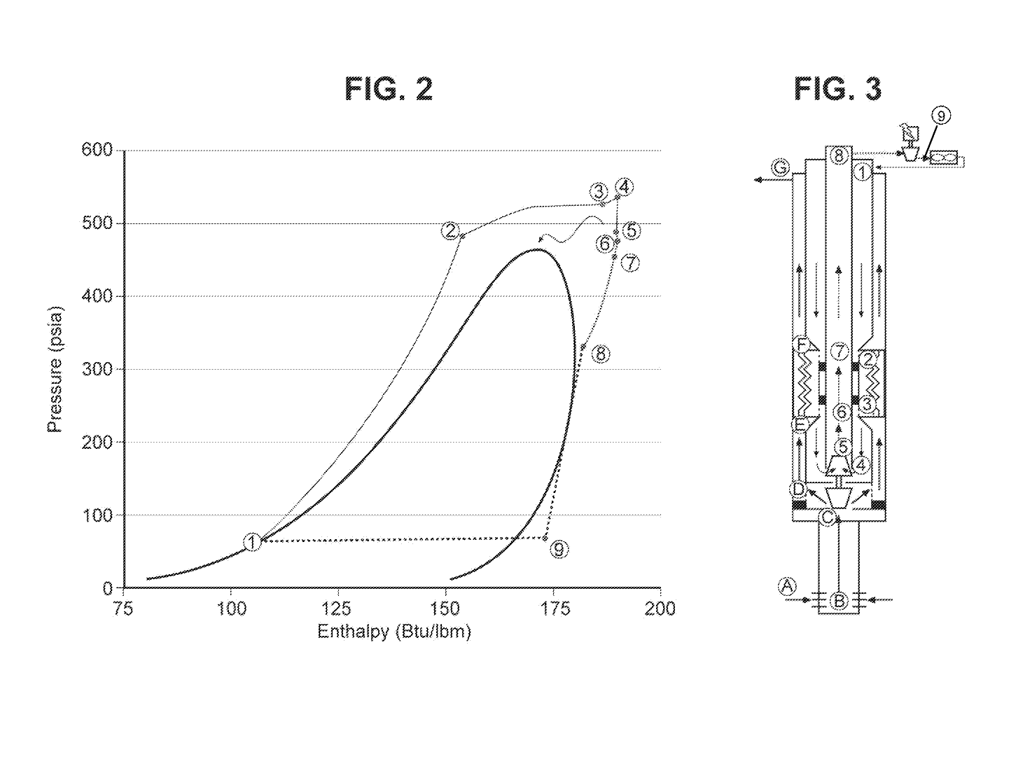

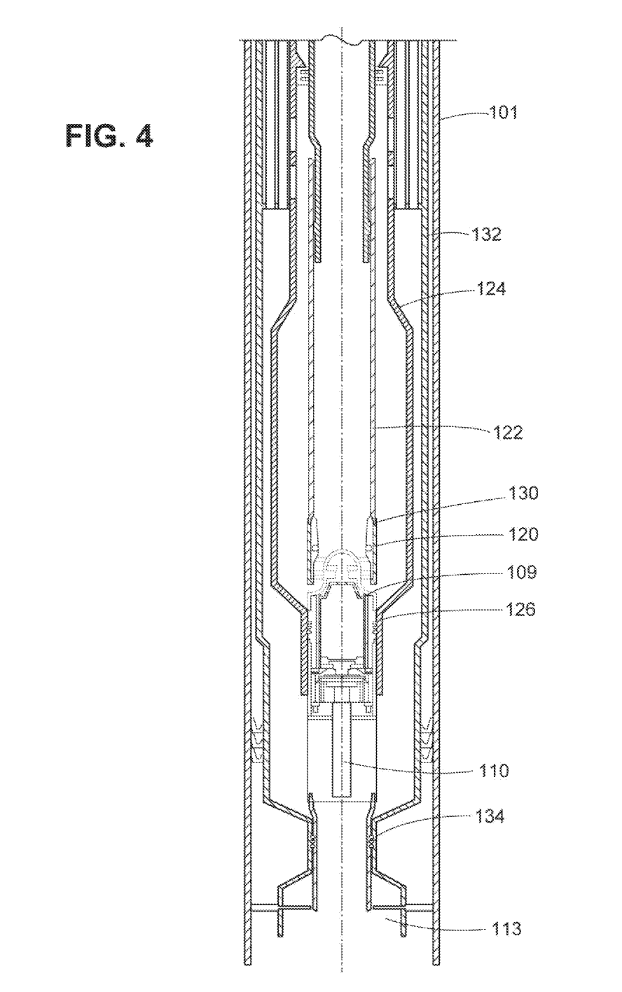

The expander pump unit 108 includes a down-hole turbine 109 coupled to a geothermal fluid pump 110. The power generating turbine 103, the condenser 104, the accumulator 105, the down-hole heat exchanger 107, and the down-hole turbine 109 are in fluid communication with each other, between which passes an organic working fluid, which completes a thermodynamic cycle described hereinbelow with reference to the state diagram shown in FIG. 2 and the schematic shown in FIG. 3. The organic working fluid can be a hydrocarbon alkane or a hydrofluorocarbon refrigerant, such as, for example, HFC236fa and HFC-245fa. The pump 110 is in fluid communication with the down-hole heat exchanger 107 and a reinjection pump 111 at the surface 112 of the well 101. Throughout the well, including the down-hole heat exchanger, the working fluid and the geothermal fluid flow in separate flow channels to avoid mixing the two fluids. The pump 110 transfers heated geothermal fluid, sometimes referred to as brine, from a production zone 113 upwards through the down-hole heat exchanger 107 to the surface 112, which then is introduced into a reinjection well, denoted by arrow 111a.

FIG. 1C is a process flow diagram of an embodiment of the geothermal power system 100. Working fluid from the surface mounted accumulator 105 flows (or may be pumped) through filters 114 before the working fluid is introduced down the well 101. The working fluid travels down the well 101 through the down-hole heat exchanger 107 to the turbine 109. The working fluid expands through the turbine 109 and exits the well 101 at the surface 112 where it then enters an expander feed separator 115. From the expander feed separator 115 the working fluid moves to the generating turbine 103 where the working fluid expands and then enters the condenser 104. The working fluid exits the condenser 104 and flows back to the accumulator 105, completing a cycle in the closed working fluid loop.

As shown with reference to FIGS. 2 and 3, the states of the working fluid in the working fluid loop shown in FIG. 3 are numbered 1 to 9. At state 1, the working fluid is a liquid. In moving to state 2, the working fluid flows down the upper section of the well 101 resulting in a pressure increase of the working fluid. Moreover, as geothermal fluid rises to the surface 112 some heat is transferred from geothermal fluid to the working fluid elevating the temperature of the fluid at state 2. In moving from state 2 to state 3, the working fluid is heated by the geothermal fluid in the down-hole heat exchanger 107, while pressure increase is minimal. In moving to state 4, below the down-hole heat exchanger 107, the pressure of the working fluid is further increased, accompanied by a small amount of heat transfer from the rising geothermal fluid. As a result of the cumulative pressure and temperature changes, at state 4 the working fluid is in a supercritical state. In one example, the pressure of the working fluid at state 4 is expected to be 573 pounds per square inch absolute and the temperature is expected to be 302 degrees Fahrenheit. In moving to state 5, the working fluid is expanded isentropically across the turbine 109 of the expander pumping unit 108. This isentropic expansion provides energy to drive the geothermal fluid pump 110. Continuing with the example at state 4, the pressure at state 5 is expected to be 526 pounds per square inch absolute. As the working fluid rises toward the surface 112 it passes through states 6 to 8 where the hot, high pressure working fluid (with reduced density) flows to the surface 112, returning as a vapor at state 8. The vaporized working fluid is expanded through the generating turbine 103 to drive the electric generator 106 and the pressure of the fluid is lowered at the exit of the turbine 103 at state 9. Thereafter, the lower pressure working fluid is passed through a condenser 104 and cooled and returns to a liquid at state 1, whereupon the working fluid is reintroduced to the well.

Also, in FIGS. 2 and 3 the states of the geothermal fluid (i.e., brine) are labeled A to G. In state A, geothermal fluid in a production zone 113 surrounds the base of the well 101. The geothermal fluid is expected to be at a temperature between 250 and 425 degrees Fahrenheit. At state B the geothermal fluid enters the well 101 and flows up to the pump 110 intake at state C. The geothermal fluid is transported axially by the pump 110 to state D. The pump 110 is driven by the turbine 109. Geothermal fluid flows up to the down-hole heat exchanger 107 at state E, transferring some heat to the working fluid. As the geothermal fluid rises in the down-hole heat exchanger 107 to state F, the geothermal fluid heats the working fluid traveling down the down-hole heat exchanger 107. In addition, the geothermal fluid flowing from state F to the surface at state G transfers some heat to the working fluid flowing down the well 101 from state 1 to state 2 in a portion of the well 101 arranged as a counter-current flow “pipe-in-pipe” heat exchanger. At state G, the geothermal fluid exits the well 101 at a desired pressure for introduction into a reinjection well 111a, which is in fluid communication with the production zone 113 at state A.

While the operation of one embodiment of the geothermal system has been described with reference to FIGS. 2 and 3, where the working fluid enters the turbine in a supercritical state, it will be appreciated by those of ordinary skill in the art that the working fluid may also enter the turbine in other physical states that are not supercritical, including, for example, single phase and dual phase.

The construction of the well 101 and the operating environment in which the expander pump unit 108 operates presents a number of design challenges for the expander pump unit 108, and in particular, the turbine 109 of the expander pump unit 108.

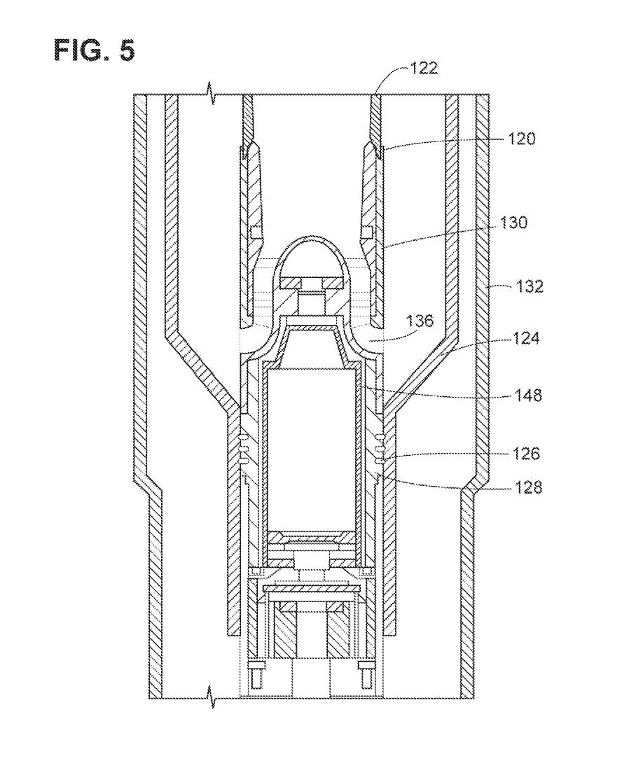

In an embodiment, the subsurface portion of the geothermal power system 100 is constructed from modular assemblies, which may be partially assembled at the surface and lowered into the geothermal well 101 in a predetermined sequence. For example, in FIGS. 4 and 5 a cross section is shown of a portion of the well 101 in which an embodiment of the expander pumping unit 108 is disposed. The turbine 109 is connected via a threaded connection 120 to a vapor outlet casing 122 which is centrally located in the well 101. Concentrically surrounding the turbine 109 and the vapor outlet casing 122 is a working fluid casing 124. The turbine 109 is sealed against the working fluid casing 124 using glide rings 126 (FIG. 5) which are seated in annular grooves 128 (FIG. 5) formed in a casing 130 of the turbine 109. The working fluid travels between the vapor outlet casing 122 and the working fluid casing 124 to the turbine 109 and the working fluid returns to the surface 112 through the vapor outlet casing 122.

Concentrically surrounding the working fluid casing 124 is a geothermal fluid (i.e., brine) casing 132. The pump 110 transports geothermal fluid upward from the well production zone 113 between the geothermal fluid casing 132 and the working fluid casing 124. The glide rings 126 surrounding the turbine 109 function to separate the working fluid from the geothermal fluid. As shown in FIG. 4, the pump also has a plurality of glide rings 134, which seal the pump 110 with the geothermal fluid casing 132.

Due to the modular construction of the subsurface portion of the geothermal power system 100 in this embodiment, the expander pumping unit 108 may be installed and removed without also removing the down-hole heat exchanger 107. Annular notches 128 are formed in the turbine casing 130 adjacent to a turbine inlet 136. The notches are constructed to receive the glide rings 126, which are constructed to seal against the working fluid casing 124 described hereinabove. The glide rings 126 facilitate installation and removal of the turbine 109 from the working fluid casing 124.

To be able to remove the expander pump unit 108 without removing the down-hole heat exchanger 107, the vapor outlet casing 122 and the expander pump unit 108 must be pulled vertically through the working fluid casing 124, whose geometry is defined in part based on the inner dimensions of the down-hole heat exchanger 107. In FIG. 4 the maximum outside diameter of the expander pump unit 108 is defined based on the geometry of the surrounding working fluid casing 124.

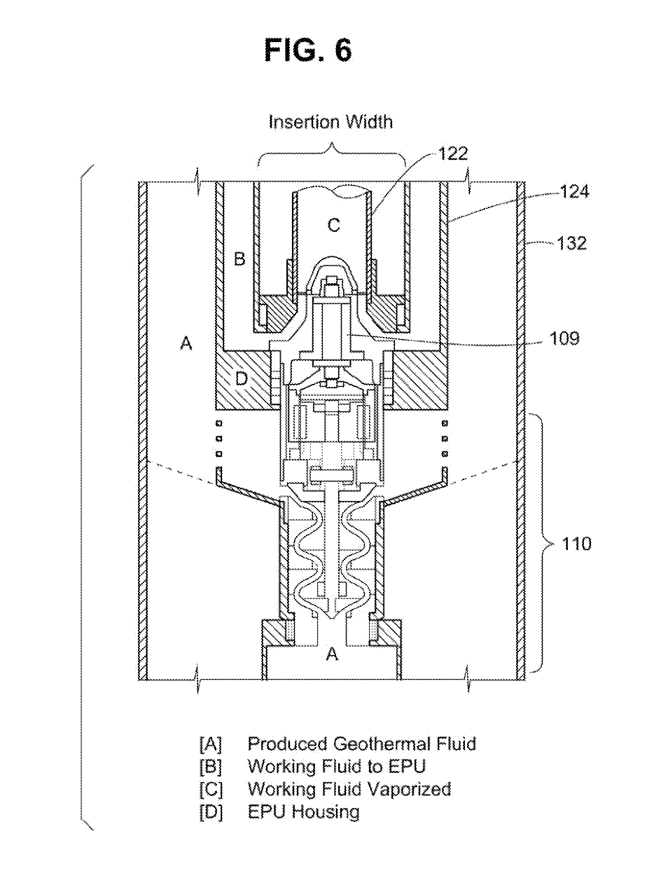

FIG. 6 shows another embodiment of an expander pumping unit 108 that has its outer dimension defined by an insertion width within the working fluid casing 124.

Although the expander pumping unit 108 is designed to be installed and removed from the geothermal well 101 without removal of the down-hole heat exchanger 107, such an operation is not desirable. To reduce occurrences of turbine 109 removal and recovery, the expander pump unit 108 is designed to operate reliably in the operating environment of the geothermal well 101. Due to the positioning of the turbine deep at a subsurface location, it is not readily possible to provide auxiliary lubrication to the turbine 109 from a surface mounted location. Also, the down-hole turbine 109 is oriented coaxially with the well 101 and large thrust bearing loads can develop during operation which may affect wear on the bearings. Finally, the turbine 109 should be arranged to drive the geothermal fluid pump while keeping the working fluid separated from the geothermal fluid. Various examples of turbines are provided herein that are suitable to avoid these issues in the down-hole operating environment.

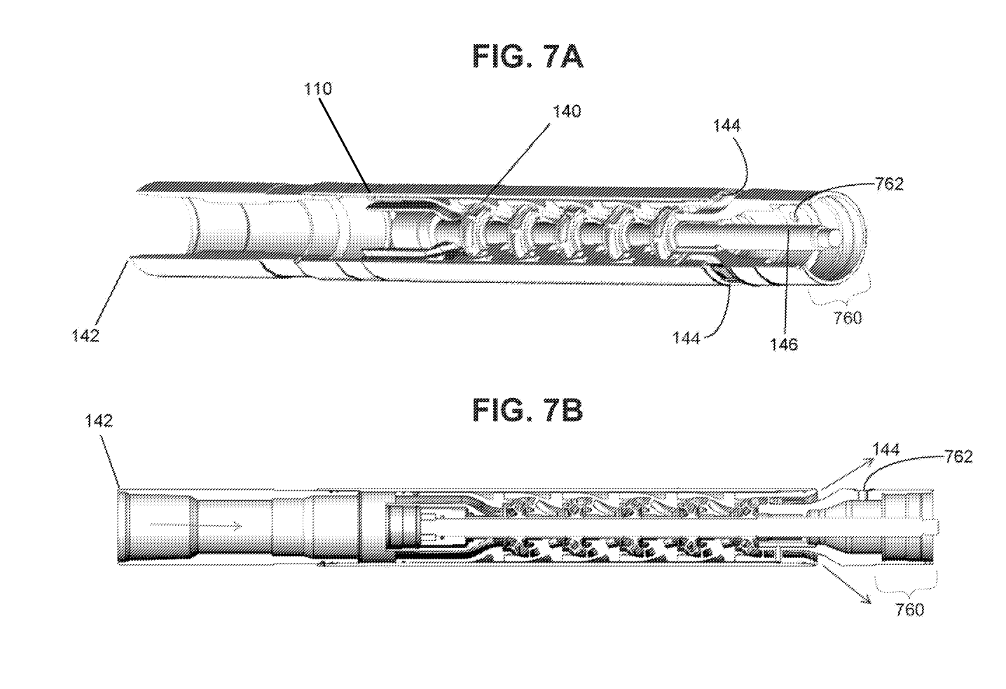

FIGS. 7A and 7B show an example of a geothermal fluid pump 110 that is coupled to the down-hole turbine 109 in accordance with an aspect of the invention. The pump 110 has a plurality of stages 140, which move fluid axially through the pump in the direction of the arrow from the inlet 142 of the pump 110 through the pump stages 140 to the exit 144, which then travels between the brine casing 132 and the working fluid casing 124 (FIGS. 4 and 5). The pump 110 has a shaft 146 which may be magnetically coupled to and driven by the down-hole turbine 109. A further description of the geothermal fluid pump 110 is omitted, as the details of a suitable pump are believed to be appreciated by those of ordinary skill in the art of geothermal systems.

Various example embodiments of the down-hole turbine are discussed hereinbelow, which are arranged in accordance with an aspect of the invention.

### Embodiment 1

In the following discussion, the phrases output end and output direction will denote a position and direction toward the surface equipment of the power system, while the phrases pump end and pump direction will denote a position and a direction toward the pump of the expander pump unit. Also, in the examples that follow, like structures will be denoted by like reference numbers.

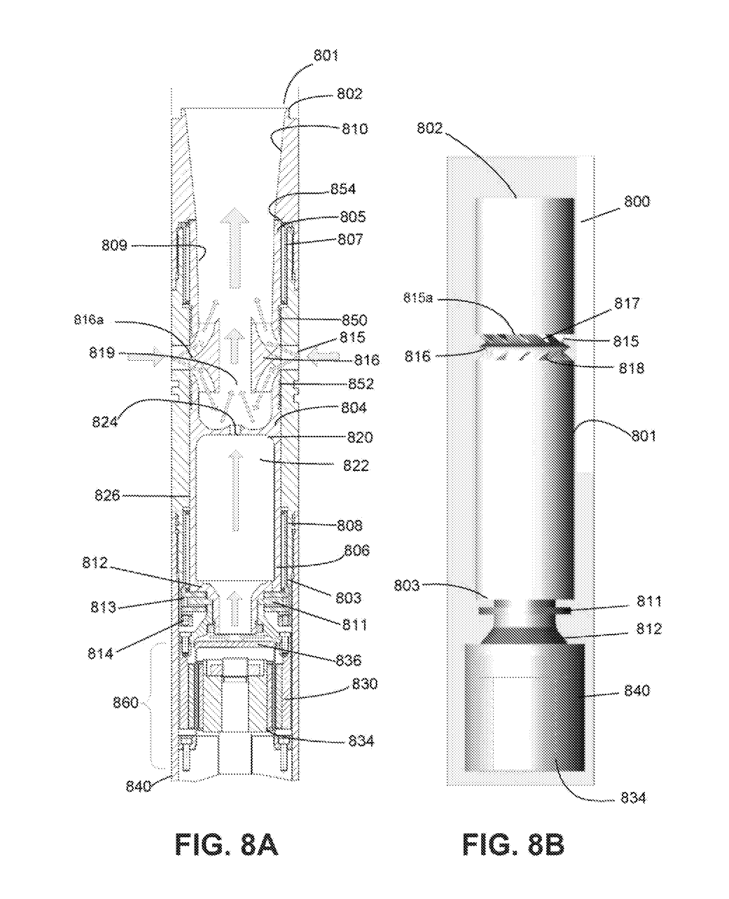

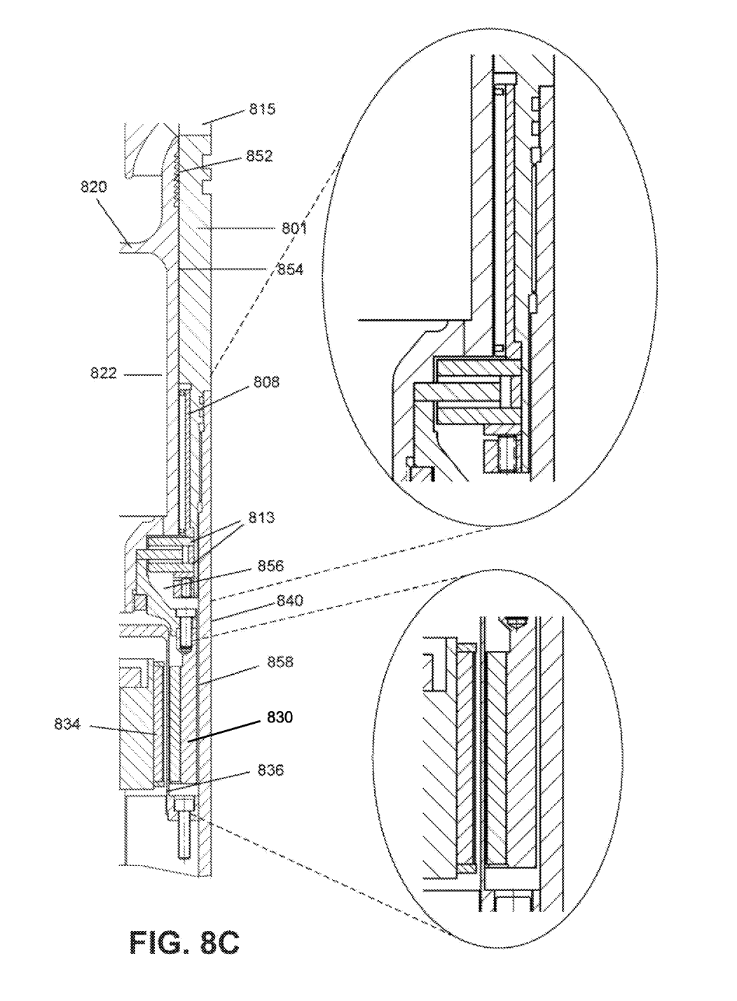

FIG. 8A shows a cross section through a first embodiment of a down-hole turbine 800 shown in FIG. 8B. The turbine 800 includes a case 801 extending axially from an outlet end 802 to a pump end 803. A pump casing 840 is attached to the pump end 803 of the turbine case 801. A turbine shaft 804 extends axially within the turbine case 801 between an outlet end 805 and a pump end 806.

The turbine shaft 804 is radially supported by an upper radial foil bearing 807 and a lower radial foil bearing 808, each respectively at the ends 805 and 806 of the turbine shaft 804. An inner frustoconical surface 809 of the outlet end 805 of the turbine shaft 804 diverges in the outlet direction toward a diverging frustoconical inner surface 810 of the turbine case 801 which extends to the outlet end 802 of the case 801. The turbine shaft 804 is constructed to rotate concentrically within the turbine case 801.

The turbine shaft 804 is axially supported by thrust bearings 813. An annular thrust plate 811 extends from a hub 812, which is connected to the pump end 806 of the turbine shaft 804. The thrust plate 811 is positioned between a pair of annular foil-type thrust bearings 813, which are retained between the lower edge of the turbine shaft 804 and a support 814 extending from the inner wall of the turbine case 801 at its pump end 803. The upper and lower radial bearings 807 and 808 are also of the foil-type. Although foil-type bearings are employed in the turbine 800, other bearing types may be used as well. The thrust bearings 813 and the radial foil bearings are constructed to be lubricated by the working fluid passing through the turbine 800, thus eliminating a need for an auxiliary lubrication fluid and an associated lubrication system.

The foil-type thrust bearings 813 have a limited thrust load carrying capacity. To maintain thrust loads within the load carrying capacity of the thrust bearings 813, especially during operation speeds of the turbine 800, the turbine 800 is provided with a configuration that attempts to minimize the resultant thrust load on the thrust bearings 813, by hydraulically balancing the thrust loads.

A radial inlet 815 is formed through the turbine case 801 leading toward a rotor 816 connected to the turbine shaft 804. As shown in FIG. 8B, the radial inlet 815 is formed by a circumferential groove 815a formed in the turbine case 801. The rotor 816 is constructed to rotate the turbine shaft 804 when the rotor 816 is impinged by working fluid entering the turbine through the radial inlet 815.

Below the flange 820 of the turbine shaft 804 is a generally cylindrical chamber 822 having an orifice 824 formed in the flange 820 which fluidly couples the chamber 822 to the passageway 819. The chamber 822 is also defined by a cylindrical wall 826 of the turbine shaft 804 which extends axially from the flange 820 toward the lower end 806 of the turbine shaft 804. The chamber wall 826 is connected to the hub 812 around which is attached the thrust bearing plate 811. The hub 812 is connected at its opposite end to an outer rotor 830 of a magnetic coupling 860 which couples the turbine shaft 804 magnetically to an inner rotor 834 connected to the geothermal fluid pump 840.

Shown in FIG. 8A, located between the inner rotor 834 and outer rotor 830 there is a non-rotating canister 836, which is fixed to the pump case 840. The canister 836 separates the working fluid in the turbine 800 from geothermal fluid in the pump 840.

In operation the working fluid enters the inlet 815 in a supercritical state as described hereinabove and impinges on the rotor 816. The impinging working fluid is then redirected by the rotor 816 and the inner surface of the turbine shaft 804 and exits at a lower density and pressure through the outlet end of the turbine 802.

The rotor 816 is constructed generally as a disk having axially opposed impellers: an upper impeller 817 and a lower impeller 818, shown in greater detail in FIG. 8B. The rotor 816 includes an axially extending passageway 819 through its center. An outer edge 816a of the rotor 816 divides the working fluid stream towards the upper impeller 817 and the lower impeller 818. The upper impeller 817 receives a first portion of the working fluid stream and the lower impeller 818 receives a second portion of the working fluid. Fluid impinging on the upper impeller 817 exerts forces on the upper impeller 817 to cause it and the turbine shaft 804 to rotate while the surfaces of the upper impeller 817 redirect the working fluid toward the outlet end 801 of the turbine 800. Fluid impinging on the lower impeller 818 also exerts forces on the lower impeller 818 to cause it and the turbine shaft 804 to rotate in the same rotational direction as the upper impeller 817. However, the lower impeller 818 redirects the second portion of the working fluid downwardly in an opposite axial direction than the fluid redirected by the upper impeller 817. The second portion of the working fluid is then redirected in an upward direction by a flange 820 below the lower impeller 818. The redirected fluid from the flange 820 travels through the center of the rotor 816 toward the outlet end 802 of the turbine 800.

Each impeller 817 and 818 produces some amount of axial thrust because of different pressures and different geometries on the two sides of the impeller. The thrust of the upper and lower impellers 817 and 818 facing in opposite directions tend to cancel out. The net thrust exerted on the thrust bearings is accordingly less than it would be if the impellers were not opposed, i.e., if both of them faced in the same direction, or if only one impeller were utilized. Thus, the movement of the working fluid within the turbine 800 in opposite axial directions contributes to a reduction in residual bearing load on the thrust bearings 813 within the load carrying capacity of the thrust bearings 813. As a result of the thrust bearing load balancing, foil-type thrust bearings 813 are a suitable choice because they do not require external lubrication.

Although the opposed impellers 817 and 818 tend to cancel their thrust forces, other surfaces of the turbine 800 also result in a net thrust load on the thrust bearings, which must be accounted for and reduced within the capacity of the thrust bearings. Another component of the thrust load caused by the configuration of the turbine 800 results from the lubrication arrangements of the upper bearing 807, the lower bearing 808, and the thrust bearings 813.

As discussed hereinabove the working fluid is used to lubricate the thrust bearings 813 and the radial foil bearings 807 and 808. Upper and lower labyrinth seals, 850 and 852, respectively, are formed circumferentially in the outer surface of the turbine shaft 804 axially above and below the inlet 815. The labyrinth seals 850 and 852 are constructed to permit a portion of the high pressure working fluid from the inlet 815 to leak between the outer surface of the turbine shaft 804 and the inner surface of the turbine case 801, which then migrates to the bearings, which are at a lower pressure than working fluid at the inlet 815.

As shown in greater detail in FIG. 8C, a working fluid pathway exists from the lower labyrinth seal 852 to the chamber 822 through the lower radial foil bearing 808 and the thrust bearings 813. Below the inlet 815, between the lower labyrinth seal 852 and the lower radial foil bearing 808, the path extends in the annular space 854 between the outer surface of the turbine shaft 804 and the inner surface of the turbine case 801. The path continues through the lower radial foil bearing 808 and extends down to the region 856 surrounding the thrust bearings 813. The path continues in an annular space 858 between the outer surface of the turbine magnet rotor 830 and the geothermal pump casing 840. The path then turns around the lower edge of the turbine magnet rotor 830 and extends in the annular space between the canister 836 and the inner surface of the turbine magnet rotor 830. The path then extends between a gap between the hub 812 and the canister 836, and then through the hub 812 and into the chamber 822. Fluid pressure exerted on the hub 812 and the lower edge of the turbine magnet rotor 830, for example, produce an upward thrust on the turbine shaft.

Fluid exiting the chamber 822, being at higher relative pressure to the fluid redirected from the lower impeller 818, continues its path through the orifice 824 in the flange 820 in a direction of bulk working fluid flow through the opening 819 of the turbine rotor 816.

The leakage flow rate through the lower labyrinth seal 852 is based on the construction of the seal 852 and the pressure differential between the inlet pressure of the working fluid at the inlet 815 and the pressure of the working fluid at the exit of the lower impeller 818. Accordingly, the amount of leakage flow through the lower radial foil bearing 808 and the thrust bearings 813 can be adjusted based on the construction of the lower labyrinth seal 852. Such adjustment of the flow rate through the lower labyrinth seal 852 therefore may also adjust the thrust force due to the flow path of working fluid in the lubrication path.

The upper labyrinth seal 850 is formed circumferentially in the outer surface of the turbine shaft 804 above the inlet 815. An annular leakage path is formed between the outer surface of the turbine shaft 804 and the inner surface of the turbine case 801 and extends axially between the upper labyrinth seal 850 and the upper radial foil bearing 807. The leakage path extends around the upper radial foil bearing 807 to the outlet end 805 of the turbine shaft 804. The leakage path continues through a transverse passage 854 formed between the edge of the outlet end 805 of the turbine shaft 804 and the surface of the turbine casing 810. The transverse passage 854 extends to the outlet 802 of the turbine where the fluid pressure is lower than at the inlet 815, thus providing a pressure differential to drive the leakage flow.

The performance of the magnetic coupling 860 may be affected by the operating temperature of the fluid therein. For example, performance, measured in terms of slip torque, may be adversely affected by as much as twelve percent as a result of operating at elevated operating temperatures in the well. To reduce performance losses in transferring input torque from the outer rotor 830 to the inner rotor 834, the geothermal fluid is used to cool the region between the canister 836 and the inner rotor 834.

Although the canister 836 separates the geothermal fluid from the working fluid, use of the canister 836 can contribute to efficiency losses of the magnetic coupling. Losses from the canister 836 may manifest as eddy current losses and losses caused by viscous drag forces (sometimes referred to as windage losses). The material composition of the canister 836 may affect eddy currents, since flux lines of the magnetic coupling 860 pass through the canister material. Moreover, conductive materials used for the canister 836 will start to heat as the rotational speed of the coupling rotors 830 and 834 increase. Conductive canister materials may lead to resistance of the coupling motion, as some of the input work will be converted into eddy current losses in the form of heat. At higher rotor speeds, the eddy current losses may not be negligible. Another inefficiency of the magnetic coupling 860 is caused by viscous drag forces, losses which have been determined to be less than the eddy current losses.

To address some of the performance considerations caused by the arrangement of the magnetic coupling 860, at the operating speed of the geothermal fluid pump 840, a portion of the duty flow of the pump 110 is diverted to the region between the inner rotor 834 and the canister 836 for cooling the magnetic coupling 860. The coupling 860 is housed in coupling section 760 of the geothermal fluid pump 110 shown in FIGS. 7A and 7B.

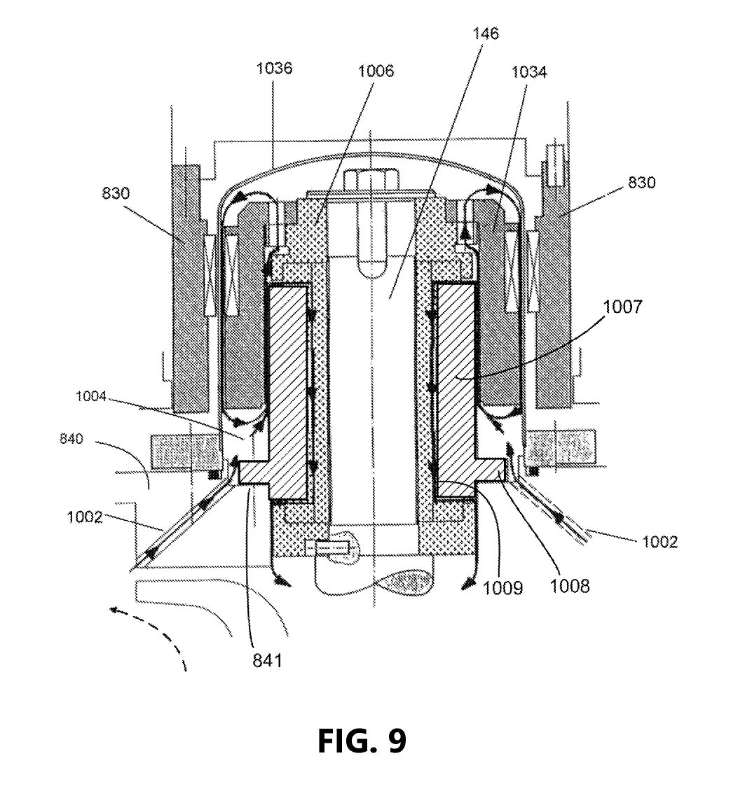

FIG. 9 shows a section view of another embodiment of a magnetic coupling 1000 in which a fluid pathway is defined, represented by solid arrows, in which geothermal fluid flows in the coupling 1000 on the geothermal fluid-side of a canister 1036. Geothermal fluid, represented by the broken lines is discharged from the pump at 144 (FIGS. 7A and 7B). In the embodiment of FIG. 9 a diagonal channel 1002 is formed in the upper portion of the pump housing 840 which directs a portion of the discharged, high-pressure geothermal fluid into the region surrounding the inner rotor 1034 of the coupling 1000. A bearing 1006 is fastened to the end of the pump shaft 146 and the inner rotor 1034 is attached to the bearing 1006. The bearing 1006 bears against a bearing housing 1007 which has a flange 1008 which seats against a flange 841 of the pump housing 840. The bearing housing 1007 is fixed with respect to the pump housing 840, while the inner rotor 1034 and the bearing 1006 rotate together with the shaft 146.

The diagonal channel 1002 terminates in an annular space 1004 defined between the lower edge of the inner rotor 1034, the bearing housing 1008, and the canister 1036. The geothermal fluid circulates between the inner surface of the inner rotor 1034 and the bearing housing 1008 and between the outer surface of the inner rotor 1034 and the canister 1036. Geothermal fluid exits to a lower pressure region along a path formed between the bearing housing 1008 and the bearing 1006 and between the bearing 1006 and the pump housing 840 in the path 1009 below the bearing housing flange 1008. The geothermal fluid moves downward from the path 1009 along the shaft 146 back toward the inlet 142 of the pump 110, which is at a lower pressure than the fluid in channel 1002. Thus, the flow of geothermal fluid through the coupling is driven by a pressure differential between the fluid in the channel 1002 and the fluid in path 1009.

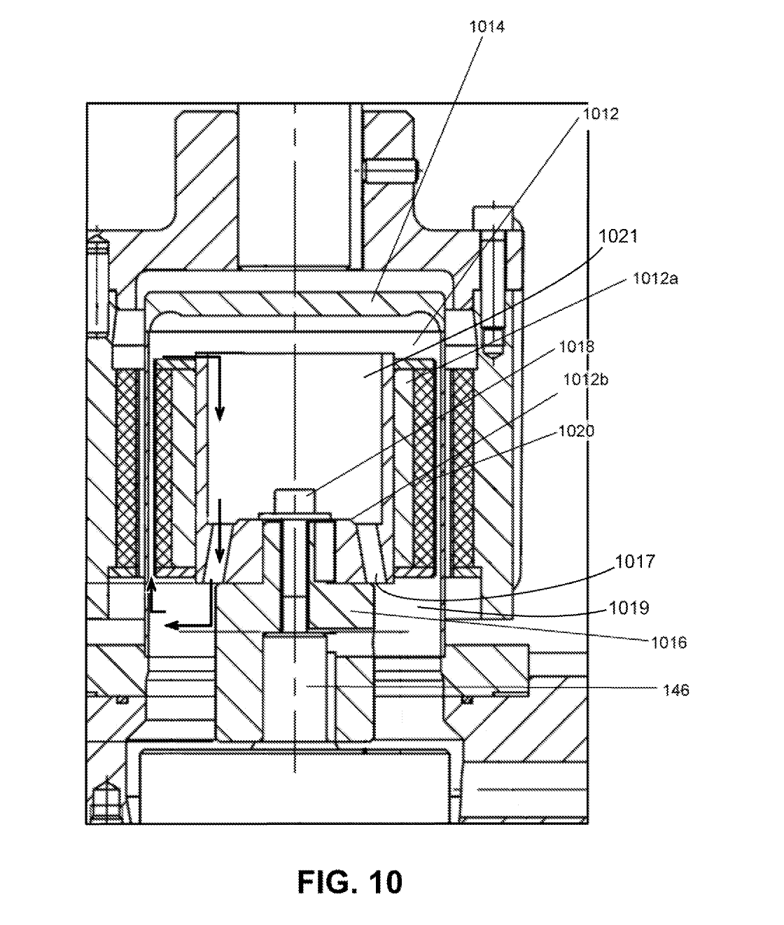

Another embodiment of a magnetic coupling 1010 is shown in FIG. 10, which is a further refinement of the coupling shown in FIG. 9. The inner rotor 1012 is constructed of a cylindrical wall 1012a attached to a base 1012b. The base 1012b is seated on a second hub 1016 which is seated on the end of the pump shaft 146. The base 1012b and the second hub 1016 have concentric openings through which a fastener 1018 extends to fasten the inner rotor 1012 to the end of the pump shaft 146. Attached to the cylindrical wall 1012a on its outer surface is a magnet 1020 facing the canister 1014. A fluid pathway is defined, represented by solid arrows, in which geothermal fluid flows in the coupling 1010 on the geothermal fluid-side of the canister 1014. In the embodiment of FIG. 10 a portion of the discharged high pressure geothermal fluid flows into a region 1019 defined by the canister 1014, the second hub 1016, and the base 1012b. The geothermal fluid circulates generally clockwise around the wall 1012a of the inner rotor 1012 in the direction of the arrows. Geothermal fluid in a cavity 1021 defined by the cylindrical wall 1012a moves downward through diagonal openings 1017, which when rotating with the shaft 146, act as a pump stage pushing geothermal fluid to region 1019. Geothermal fluid then moves between the canister 1014 and the outer surface of the cylindrical wall 1012a, whereupon it returns to the cavity 1021.

In one embodiment, geothermal fluid enters the coupling through an opening in the pump housing 840, such as through port 762 (FIGS. 7A and 7B), and moves to region 1019. In one embodiment, the structure of the coupling 1010 is constructed to dissipate heat from the geothermal fluid circulating in the inner rotor 1012. In one embodiment, the heat dissipation may be sufficient to mitigate renewing the geothermal fluid in the inner rotor 1012.

### Embodiment 2

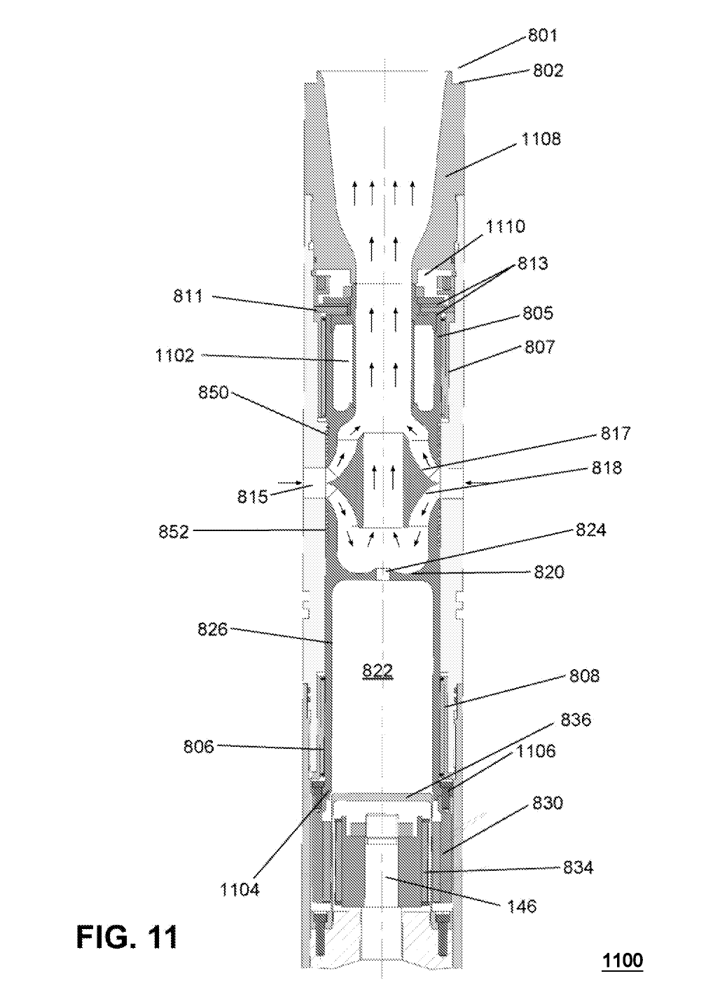

The second embodiment of a turbine 1100 in accordance with an aspect of the invention is shown in FIG. 11 and is an alternate arrangement of the turbine 800 of the first embodiment shown in FIGS. 8A and 8B. Elements corresponding to the turbine 800 will be numbered alike for the turbine 1100. One distinction between the first and second embodiments is that the thrust bearings 813 of the second embodiment support the turbine shaft 804 from its outlet end 805 instead of at the pump end 806 of the turbine shaft 804, as arranged in the first embodiment. Moreover, to accommodate the thrust bearings 813 at the outlet end 805 of the turbine shaft 804, the turbine shaft 804 of the second embodiment has a substantially cylindrical inner surface 1102 extending between the rotor 816 and the outlet end 805 of the turbine shaft 804, and instead of a frustoconical inner surface of the turbine case 801 at its outlet end 802 a diverging nozzle 1108 is attached and receives outlet flow of working fluid from the outlet end 805 of the turbine shaft 804. Also, instead of the cylindrical hub 812 at the pump end of the cylindrical chamber 822, the cylindrical wall 826 of the chamber 822 of the turbine 1100 has an annular flange 1104 extending from the cylindrical wall, which is attached via fasteners 1106 to the outer rotor 830 of the magnetic coupling 860. The arrangement of the magnetic coupling 860 and the radial foil bearings 807 and 808 is otherwise the same as that described for the turbine 800, and therefore the details thereof are not repeated for the sake of brevity.

A thrust balance chamber 1110 is formed between the diverging nozzle and the thrust bearings 813. As with the turbine 800, leakage flow of working fluid moves in a pathway between the labyrinth seal 850 and the outlet end 805 of the turbine shaft. By virtue of the chamber 1110, leaked working fluid exerts pressure in the downward direction on the thrust bearings 813 in opposition to the upward forces exerted by the leakage flow through labyrinth seal 852.

### Embodiment 3

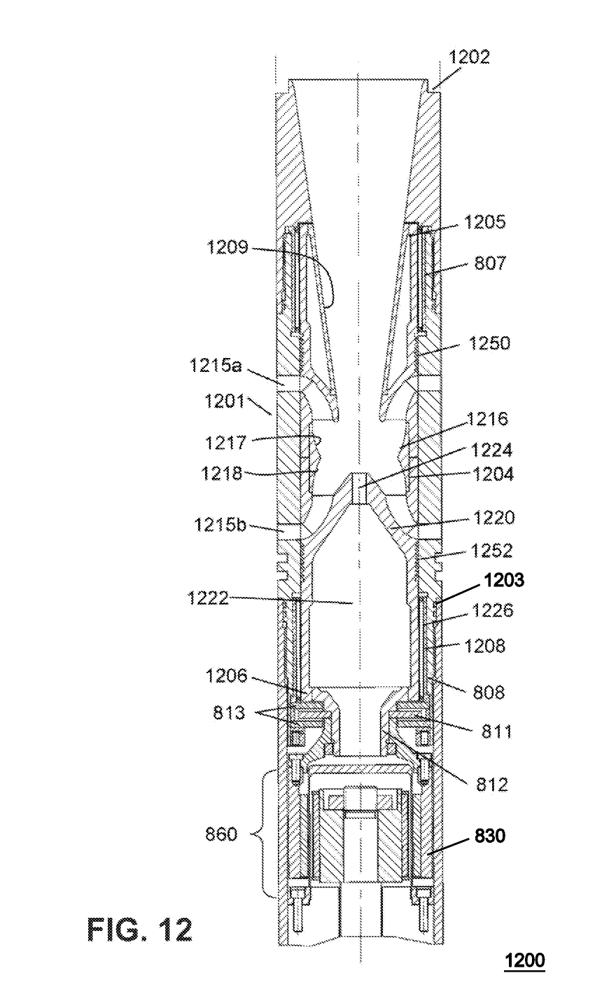

A cross sectional view of a third embodiment of a turbine 1200 is shown in FIG. 12. The turbine 1200 includes a case 1201 extending axially from a first, outlet end 1202 to a second, pump end 1203. Inside the turbine case 1201 is a turbine shaft 1204 extending coaxially with the case 1201. The turbine shaft 1204 also has an outlet end 1205 and a pump end 1206. The turbine shaft 1204 is supported radially by an upper radial foil bearing 807 and a lower radial foil bearing 808 between the turbine shaft 1204 and the case 1201. The upper and lower radial foil bearings 807 and 808 are disposed in annular grooves formed in the inner surface of the turbine case 1201. The radial foil bearings 807 and 808 are positioned at the ends 1205 and 1206, respectively, of the turbine shaft. The turbine shaft 1204 is axially supported by thrust bearings 813 at the pump end 1206 of the turbine shaft 1204. The turbine shaft 1204 is constructed to rotate within the turbine case 1201 when superheated working fluid enters the turbine through an upper inlet 1215a and a lower inlet 1215b formed in the turbine case 1201 and impinges on a rotor 1216.

The turbine shaft 1204 has an inner frustoconical surface that expands radially in the outlet direction between the rotor 1216 and the outlet end 1205 of the turbine shaft 1204. The outer surface of the turbine shaft 1204 between the rotor 1216 and the outlet end 1205 is cylindrical and is partially surrounded by the upper radial foil bearing 807. The upper radial foil bearing 807 extends axially from the outlet end 1205 of the turbine shaft 1204 in a direction towards an upper labyrinth seal 1250, which is formed in the outer surface of the turbine shaft 1204 above upper inlet 1215a. The upper radial foil bearing 807 is received in an annular groove formed in the inner surface of the turbine case 1201 around the outlet end 1205 of the turbine shaft 1204.

The inlets 1215a and 1215b are axially spaced across the rotor 1216. The rotor 1216 has axially opposed upper and lower impellers, 1217 and 1218, respectively, formed in the wall of the turbine shaft 1204. The inner surface 1209 of the turbine shaft 1204 directly above the rotor 1216 extends axially down beyond the upper inlet 1215a and has a curved surface, which redirects fluid entering the upper inlet 1215a in the downward direction toward the upper impeller 1217. The redirection of the working fluid downward toward the upper impeller 1217 acts to reduce the resultant thrust load on the thrust bearings 813. The downwardly directed fluid impinges on the curved upper impeller 1217 and rotates the rotor 1216 and the turbine shaft 1204.

Similar to the chamber 822 of the first and second embodiments, the third embodiment of the turbine also includes a chamber 1222 below the rotor 1216 defined by a flange 1220 and a cylindrical wall 1226. The flange 1220 of the chamber 1222 protrudes axially upward beyond the lower inlet 1215b and forms a curved surface which redirects fluid entering the lower inlet 1215b in an upward direction toward the lower impeller 1218. The upwardly directed fluid impinges on the lower impeller 1218 and rotates the rotor and the turbine shaft 1204.

The pump end of the chamber 1222 is attached to the hub 812 which is attached to the outer rotor 830 of magnetic coupling 860. Accordingly, the pump end of the chamber 1222 is arranged in the same manner as the turbine 800, and thus a description of the corresponding arrangement of the turbine 1200 is not repeated for the sake of brevity.

Moreover, the upper and lower radial foil bearings 807 and 808, and the thrust bearings 813, are lubricated in the same manner as the corresponding elements of the turbine 800. That is, the bearings 807, 808, and 813 of the turbine 1200 receive working fluid that leaks past upper and lower labyrinth seals 1250 and 1252 due to a pressure differential between the working fluid pressure at the inlets 1215a and 1215b and the working fluid pressure at the bearings. Fluid passing the lower radial foil bearing 808 also returns into the chamber 1222 and is expelled from the chamber 1222 through an orifice 1224 in the chamber flange 1220 in the same manner as the working fluid expelled through the orifice 824 in connection with turbine 800. Accordingly, a detailed description of the lubrication pathways of turbine 1200 also is not repeated.

### Embodiment 4

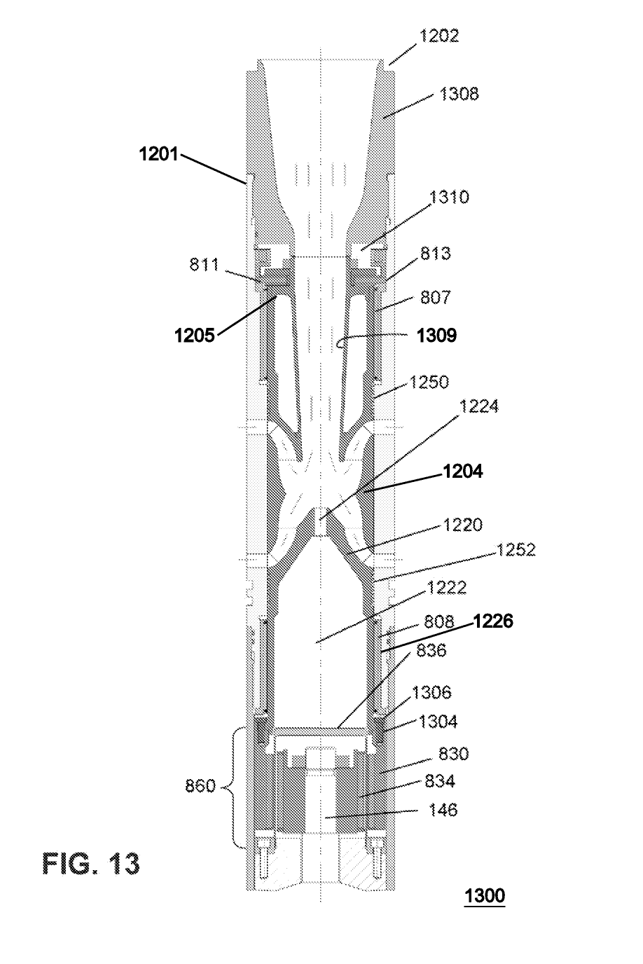

A fourth embodiment of a turbine 1300 in accordance with an aspect of the invention is shown in FIG. 13, and is an alternate arrangement of the turbine 1200. The turbine 1300 has a modified chamber 1222 and a modified inner surface 1309 at its outlet end 1205 caused by a relocation of the thrust bearings 813 at the outlet end 1205 of the turbine shaft 1204.

Distinguished from the chamber 1222 of the turbine 1200, the chamber 1222 of the turbine 1300 is not attached to hub 812. Instead, the cylindrical wall 1226 of the chamber 1222 of the turbine 1300 has an annular flange 1304 at the pump end of the chamber 1222, which is attached via fasteners 1306 to the outer rotor 830 of the magnetic coupling 860. The arrangement of the magnetic coupling 860 is otherwise the same as that used in conjunction with the turbine 800.

The inner frustoconical surface 1309 of the turbine shaft 1204 is tapered at a shallower angle than the surface 1209 in order to accommodate thrust bearings 813 at the outlet end of the turbine shaft 1204. Due to the reduced diameter at the outlet end 1205 of the turbine shaft 1204, a diverging nozzle 1308 is attached at the outlet end 1202 of the turbine casing 1201.

The turbine 1300 also includes upper and lower radial foil bearings 807 and 808, respectively, and the upper and lower labyrinth seals 1250 and 1252, respectively. Lubrication of the upper radial foil bearing 807 and the thrust bearings 813 is accomplished by working fluid leakage past the upper labyrinth seal 1250 to the bearings and out a clearance gap between an outlet end 1205 of the turbine shaft 1204 and the diverging nozzle 1308. Lubrication of the lower radial foil bearing 808 also is accomplished by leakage flow past the lower labyrinth seal 1252 to the foil bearing 808 and into the chamber 1222. Fluid entering the chamber 1222 also is expelled through the orifice 1224 in the flange 1220.

Similar to the thrust balance chamber 1110 of the turbine 1100, the turbine 1300 includes a thrust balance chamber 1310 formed between the diverging nozzle 1308 and the thrust bearings 813. By virtue of the chamber 1310, leaked working fluid exerts pressure in the downward direction on the thrust bearings 813 in opposition to the upward forces exerted by the leakage flow through labyrinth seal 1252.

### Embodiment 5

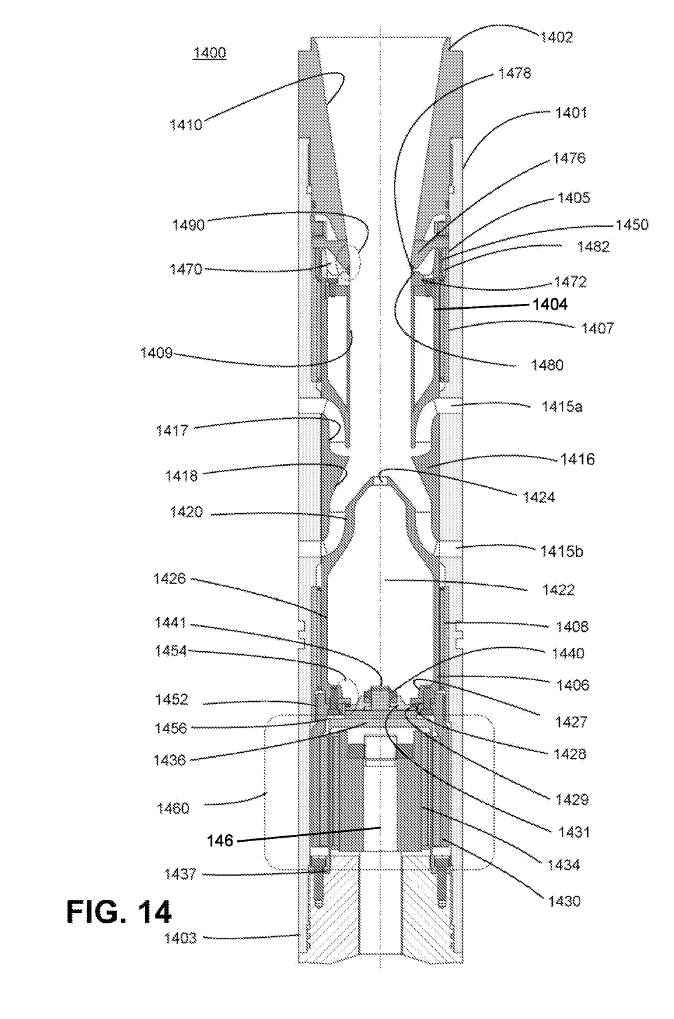

A fifth embodiment of a turbine 1400 in accordance with an aspect of the invention is shown in FIG. 14. The turbine 1400 differs from the turbines 800, 1100, 1200, and 1300 in that it does not include any thrust bearings. Instead, the turbine 1400 employs a thrust balance drum to provide hydraulic balancing of the turbine shaft between two circumferential seals at opposite ends of the turbine shaft, described in further detail hereinbelow.

The turbine 1400 includes a case 1401 extending axially from an outlet end 1402 to a pump end 1403. The turbine case 1401 is constructed to attach to a pump casing (not shown) at the lower end 1403 of the turbine case 1401. A turbine shaft 1404 extends axially within the turbine case 1401 between an outlet end 1405 and a pump end 1406. An inner surface 1409 of the outlet end 1405 of the turbine shaft 1404 extends in the outlet direction toward a diverging frustoconical inner surface 1410 of the turbine case 1401. The inner surface extends to the outlet end 1402 of the case 1401.

The turbine shaft 1404 is constructed to rotate within the turbine case 1401 when superheated working fluid enters the turbine through an upper inlet 1415a and a lower inlet 1415b formed in the turbine case 1401 and impinges on a rotor 1416. The turbine shaft 1404 is radially supported by an upper radial foil bearing 1407 and a lower radial foil bearing 1408, each respectively at the ends 1405 and 1406 of the turbine shaft 1404. The radial foil bearings 1407 and 1408 are constructed to be lubricated by the working fluid passing through the turbine 1400, thus eliminating a need for an auxiliary lubrication fluid and an associated lubrication system. Although foil-type bearings are employed in the turbine 1400, other bearing types may be used as well.

The outer surface of the turbine shaft 1404, between the rotor 1416 and the outlet end 1405, is cylindrical and is partially surrounded by the upper radial foil bearing 1407. The upper radial foil bearing 1407 extends axially from the outlet end 1405 of the turbine shaft 1404 in a direction towards the inlet 1415a. The upper radial foil bearing 1407 is received in an annular groove formed in the inner surface of the turbine case 1401 around the outlet end 1405 of the turbine shaft 1404.

The inlets 1415a and 1415b are axially spaced across the rotor 1416. The rotor 1416 has axially opposed upper and lower impellers, 1417 and 1418, respectively, formed in the wall of the turbine shaft 1404. The inner surface 1409 of the turbine shaft 1404 directly above the rotor 1416 extends axially down beyond the upper inlet 1415a and has a curved surface, which redirects fluid entering the upper inlet 1415a in the downward direction toward the upper impeller 1417. The downwardly directed fluid impinges on the curved upper impeller 1417 and rotates the rotor 1416 and the turbine shaft 1404.

The lower portion of the turbine shaft includes a chamber 1422 below the rotor 1416 defined by a flange 1420 and a cylindrical wall 1426. The flange 1420 of the chamber 1422 protrudes axially upward beyond the lower inlet 1415b and forms a curved surface which redirects fluid entering the lower inlet 1415b in an upward direction toward the lower impeller 1418. The upwardly directed fluid impinges on the lower impeller 1418 and rotates the rotor and the turbine shaft 1404. An orifice 1424 is formed at the center of the flange 1420.

The pump end of the chamber 1422 has an annular flange 1427 which extends inwardly and has a lower sealing surface 1428 at its radially inner edge. A lower chamber valve 1454 is formed by the lower sealing surface 1428 and a seal 1429 of a lower valve plate 1431, described in greater detail hereinbelow. The flange 1427 is otherwise fastened to an outer rotor 1430 of a magnetic coupling 1460.

The outer rotor 1430 has at its upper end a labyrinth seal 1452 formed in the outer surface of the outer rotor 1430. The labyrinth seal 1452 faces a sealing surface 1453 of the lower radial foil bearing 1408. The magnetic coupling 1460 also includes an inner rotor 1434 which is attached to the shaft 146 of the geothermal fluid pump 110. A canister 1436 is disposed between the inner rotor 1434 and the outer rotor 1430. The canister 1436 is attached to a flange 1437 extending from the turbine case 1401 below the outer rotor 1430. The canister 1436 separates geothermal fluid on the inner rotor 1434 side of the canister 1436 from working fluid on the outer rotor 1430 side of the canister 1436.

The lower valve plate 1431 is mounted to a base of the canister 1436. The valve plate 1431 is generally cylindrical and does not rotate with the turbine shaft 1404. A lower chamber valve seal 1429 is disposed on the upper surface of the valve plate 1431 at its outer edge. The lower chamber valve seal 1429 is constructed to seal against the lower sealing surface 1428 of the flange 1427. The lower chamber valve seal 1429 may be constructed from a low friction material that can also withstand high temperatures. One suitable material of the seal includes polyether ether ketone (PEEK). Of course, other suitable materials exist and are within the scope of the invention.

The lower valve plate 1431 is spaced a small distance from the base of the canister 1436 and is supported by a plate adjustment mechanism 1440, which permits three dimensional adjustment of the positioning of the plane of the lower valve plate 1431 relative to the sealing surface 1428. The plate adjustment mechanism 1440 includes a central post 1441 extending from the base of the canister 1436. At the upper end of the post 1441 is a ball joint to which is attached the lower valve plate 1431. The ball joint permits articulation of the lower valve plate 1431.

At startup of the turbine 1400, due to the weight of the turbine shaft 1404, the lower chamber valve 1454 is closed. That is, at startup, the sealing surface 1428 of the flange 1427 is in contact with the lower seal 1429. Due to manufacturing tolerances, the sealing surface 1428 may not lie exactly parallel to the lower seal 1429. Accordingly, to ensure a uniform seal along sealing surface 1428, the lower valve plate 1431 articulates on post 1441 to self-adjust to the sealing surface 1428 of the flange 1427.

A lower thrust balance chamber 1456 is formed in the spaces between the lower labyrinth seal 1452 and the lower chamber valve 1454. As discussed above, at startup the lower chamber valve 1454 is closed, thus also sealing the lower thrust chamber 1456. High pressure working fluid entering the turbine 1400 through lower inlet 1415b leaks between the turbine case 1401 and the turbine shaft 1404 and travels downward to lubricate the lower foil bearing 1408. The traveling working fluid then passes through the lower chamber labyrinth seal 1452 and down around the annular outer rotor 1430. The working fluid then fills the lower thrust balance chamber 1456 while the turbine shaft 1404 begins rotating. Eventually, pressure in the lower thrust balance chamber 1456 increases to a level which forces the lower chamber valve 1454 to open, releasing the leaked working fluid into the lower chamber 1422, causing the turbine shaft 1404 to move axially upward. Working fluid in the chamber 1422 can escape through orifice 1424.

To balance the axial movement of the turbine shaft 1404, an upper thrust balance chamber 1470 and an upper chamber valve 1490 is provided on the upper end 1405 of the turbine shaft 1404. The upper thrust balance chamber 1470 is formed between an L-shaped annular channel 1472, which is fastened to an upper edge of the turbine shaft 1474, and an upper sealing flange 1476 extending from the turbine case. The upper sealing flange 1476 includes an upper seal 1478, which is constructed to seal against a sealing surface 1480 of the inner edge of the channel 1472. The upper chamber valve 1490 is formed by the upper sealing flange 1476, the upper seal 1478, and the sealing surface 1480. The upper seal 1478 is constructed, for example, from a low friction material that can also withstand high temperatures. One suitable material of the seal includes polyether ether ketone (PEEK). Of course other suitable materials exist and are within the scope of the invention.

A labyrinth ring 1482 is attached to an upper annular surface of the upper radial foil bearing 1408. The labyrinth seal 1450 is formed in the inner surface of the labyrinth ring 1482. The labyrinth seal 1450 bears against the radially outer surface of the channel 1472. In operation, high pressure fluid from the inlet 1415a leaks between the turbine case 1401 and the turbine shaft 1404 and passes through the upper foil bearing 1407, to lubricate the bearing 1407, and on to the upper labyrinth seal 1450. Working fluid leaks past the upper labyrinth seal 1450 into the upper thrust balance chamber 1470. Fluid in the upper thrust balance chamber 1470 exerts pressure between the channel 1472 and the sealing flange 1476 tending to open the upper chamber valve 1490 and thus moving the turbine shaft in the downward direction.

As discussed above, at startup, the weight of the turbine shaft 1404 causes the turbine shaft 1404 to rest on the lower valve plate 1431, thus closing the lower chamber valve 1454. When sufficient working fluid pressure builds to open the lower chamber valve 1454, the turbine shaft 1404 will axially translate upward. However, during the startup phase, working fluid will leak past the open upper chamber valve 1490. As the turbine shaft 1404 begins to move upward, the opening between the upper seal 1478 and the upper sealing surface 1480 will be reduced, increasing the pressure in the upper thrust balance chamber 1470. The increasing pressure in the upper thrust balance chamber 1470 will be transmitted to the upper edge of the turbine shaft 1404 via the channel 1472 to produce a downward directed force in opposition to the upward force exerted by the fluid in the lower thrust balance chamber 1456. Eventually, an equilibrium will be reached between the opposing axial forces on the turbine shaft 1404 which permit the turbine shaft 1404 to rotate between the upper and lower seals 1478 and 1429, such that the upper and lower chamber valves 1490 and 1454 will be at least partially opened.

### Embodiment 6

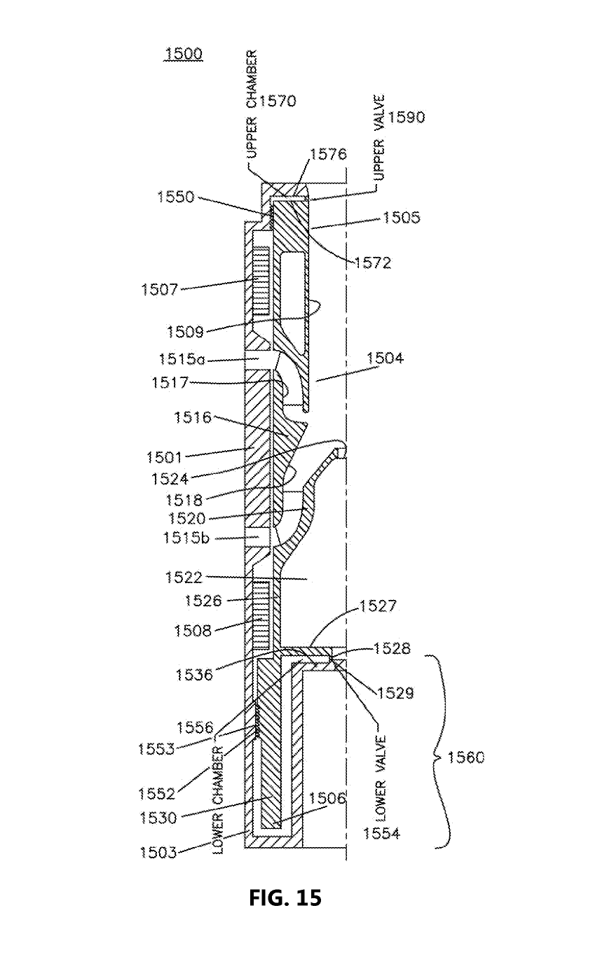

A sixth embodiment of a turbine 1500 in accordance with an aspect of the invention is shown partially in FIG. 15. Turbine 1500 differs from turbine 1400 in various structural ways, although operation of turbine 1500 is similar to turbine 1400. Certain features of the portion of the turbine 1500 shown in FIG. 15 are similar to features of turbine 1400. For example, turbine 1500 does not include any thrust bearings, similar to turbine 1400. Also, a balance drum concept is employed to provide hydraulic balancing of a turbine shaft 1504 between two balance chambers, 1570 and 1556, at opposite ends of the turbine shaft 1504, which function in the same manner as chambers 1470 and 1456, described hereinabove with respect to turbine 1400.

Turbine 1500 includes a case 1501 extending axially from an outlet end (not shown) to a pump end 1503. The portion of the case 1501 shown in FIG. 15 is a balance drum in which the turbine shaft 1516 operates. The turbine case 1501 is constructed to attach to a pump casing (not shown) at the pump or lower end 1503 of the turbine case 1501. The turbine shaft 1504 extends axially within the turbine case 1501 between an outlet end 1505 and a pump end 1506. An inner surface 1509 of the outlet end 1505 of the turbine shaft 1504 extends in the outlet direction toward an upper chamber valve 1590 between the balance drum and the turbine shaft 1504.

Similar to turbine 1400, turbine 1500 includes upper and lower balance chambers 1570 and 1556, as mentioned above. The upper balance chamber 1570 is operatively closed by an upper valve 1590 and the lower balance chamber 1556 is operatively closed by a lower valve 1554. As described above with respect to corresponding valves 1490 and 1454 of turbine 1400, in turbine 1500, pressurized working fluid in the balance chambers 1570 and 1556 supports the turbine shaft 1504 during rotation of the turbine shaft 1504 within the turbine case 1501.

The turbine shaft 1504 is constructed to rotate within the turbine case 1501 when superheated working fluid, which enters the turbine 1500 through an upper inlet 1515a and a lower inlet 1515b formed in the turbine case 1501, impinges on a rotor 1516. The turbine shaft 1504 is radially supported by an upper radial foil bearing 1507 and a lower radial foil bearing 1508, each respectively at the ends 1505 and 1506 of the turbine shaft 1504. The radial foil bearings 1507 and 1508 are constructed to be lubricated by the working fluid passing through turbine 1500, thus eliminating a need for an auxiliary lubrication fluid and an associated lubrication system. Although foil-type bearings are employed in turbine 1500, other bearing types may be used as well.

The outer surface of the turbine shaft 1504, between the rotor 1516 and the outlet end 1505, is cylindrical and is partially surrounded by the upper radial foil bearing 1507.

The inlets 1515a and 1515b are axially spaced across the rotor 1516. The rotor 1516 has axially opposed upper and lower impellers, 1517 and 1518, respectively, formed in the wall of the turbine shaft 1504. The inner surface 1509 of the turbine shaft 1504 directly above the rotor 1516 extends axially down beyond the upper inlet 1515a and has a curved surface, which redirects fluid entering the upper inlet 1515a in the downward direction toward the upper impeller 1517. The downwardly directed fluid impinges on the curved upper impeller 1517 and rotates the rotor 1516 and the turbine shaft 1504.

The lower portion of the turbine shaft 1504 includes a chamber 1522 below the rotor 1516 defined by a flange 1520 and a cylindrical wall 1526. The flange 1520 of the chamber 1522 protrudes axially upward beyond the lower inlet 1515b and forms a curved surface which redirects fluid entering the lower inlet 1515b in an upward direction toward the lower impeller 1518. The upwardly directed fluid impinges on the lower impeller 1518 and rotates the rotor 1516 and the turbine shaft 1504. An orifice 1524 is formed at the center of the flange 1520.

Unlike turbine 1400 shown in FIG. 14, the pump end of the chamber 1522 has an integrally formed annular flange 1527, which extends inwardly and has a lower sealing surface 1528 at its radially inner edge. A lower chamber valve 1554 is formed by the lower sealing surface 1528 and a seal 1529 formed on the upper portion of a canister 1536, described in greater detail hereinbelow. Also, an outer rotor 1530 of a magnetic coupling 1560 is integrally formed with the pump end of the chamber 1522 and extends axially therefrom. The outer rotor 1530 has at its upper end a labyrinth seal 1552 formed in the outer surface of the outer rotor 1530. The labyrinth seal 1552 faces a sealing surface 1553 of the turbine case 1501 axially below the lower radial foil bearing 1508.

The canister 1536 of the magnetic coupling 1560 is integrally formed with the lower end 1503 of the turbine case 1501.

The aforementioned lower chamber valve seal 1529 is disposed on the upper surface of the canister 1536. The lower chamber valve seal 1529 is constructed to seal against the lower sealing surface 1528 of the flange 1527. A lower thrust balance chamber 1556 is formed in the spaces between the lower labyrinth seal 1552 and the lower chamber valve 1554.

To balance the axial movement of the turbine shaft 1504, an upper thrust balance chamber 1570 and an upper chamber valve 1590 is provided on the upper end 1505 of the turbine shaft 1504. The upper thrust balance chamber 1570 is defined by an upper sealing flange 1576 extending from the turbine case, an upper edge 1572 of the turbine shaft 1504, and the upper labyrinth seal 1550. The upper chamber valve 1590 is formed by the upper sealing flange 1576 and the upper edge 1572 which are constructed to operatively increase and decrease the axial distance therebetween in response to fluid pressure in the upper thrust balance chamber.

At startup of the turbine 1500, due to the weight of the turbine shaft 1504, the lower chamber valve 1554 is closed. That is, at startup, the sealing surface 1528 of the flange 1527 is in contact with the lower seal 1529, thus also sealing the lower thrust chamber 1556. High pressure working fluid entering the turbine 1500 through lower inlet 1515b leaks between the turbine case 1501 and the turbine shaft 1504 and travels downward to lubricate the lower foil bearing 1508. The traveling working fluid then passes through the lower chamber labyrinth seal 1552 and down around the annular outer rotor 1530. The working fluid then fills the lower thrust balance chamber 1556 while the turbine shaft 1504 begins rotating. Eventually, pressure in the lower thrust balance chamber 1556 increases to a level which forces the lower chamber valve 1554 to open, releasing the leaked working fluid into the lower chamber 1522, causing the turbine shaft 1504 to move axially upward. Working fluid in the chamber 1522 can escape through orifice 1524.

The operation of the upper chamber valve 1590 and the lower chamber valve 1554 is the same as that of the upper chamber valve 1490 and the lower chamber valve 1454 of turbine 1400, and therefore a further explanation of that operation is not repeated for the sake of brevity.

### Embodiment 7

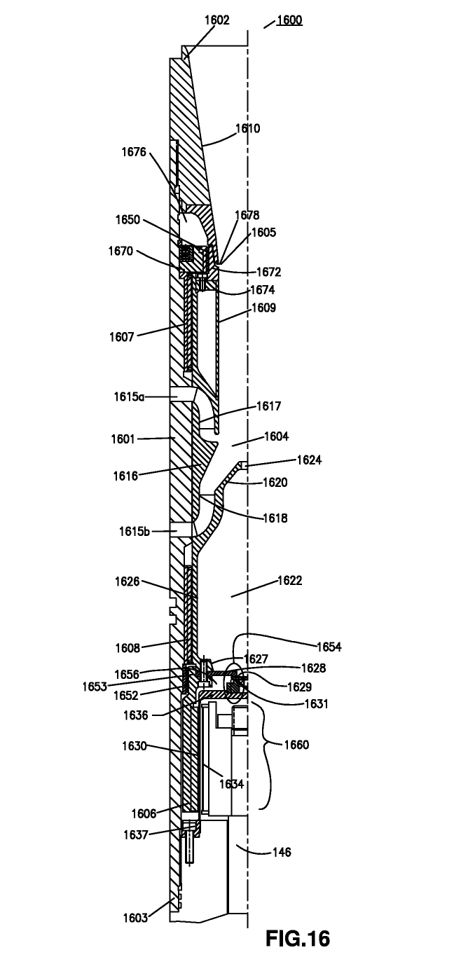

FIG. 16 shows yet another turbine 1600 in accordance with an embodiment of the invention. Turbine 1600 includes similar features to turbines 1400 and 1500 in that turbine 1600 employs a dual radial inlet configuration with a balance drum and does not include thrust bearings. However, unlike turbines 1400 and 1500, turbine 1600 employs a balance drum with a single balance chamber at the lower end of a turbine shaft 1604.

Turbine 1600 includes a case 1601 extending axially from an outlet end 1602 to a pump end 1603. The turbine case 1601 is constructed to attach to a pump casing (not shown) at the lower end 1603 of the turbine case 1601. Turbine shaft 1604 extends axially within the turbine case 1601 between an outlet end 1605 and a pump end 1606. An inner surface 1609 of the outlet end 1605 the turbine shaft 1604 extends in the outlet direction toward a diverging frustoconical inner surface 1610 of the turbine case 1601. The inner surface 1610 extends to the outlet end 1602 of the case 1601.

The turbine shaft 1604 is constructed to rotate within the turbine case 1601 when superheated working fluid, which enters turbine 1600 through an upper inlet 1615a and a lower inlet 1615b formed in the turbine case 1601, impinges on a rotor 1616. The turbine shaft 1604 is radially supported by an upper radial foil bearing 1607 above the upper inlet 1615a. The turbine shaft 1604 also is radially supported by a lower radial foil bearing 1608 below the lower inlet 1615b. The radial foil bearings 1607 and 1608 are constructed to be lubricated by the working fluid passing through turbine 1600, thus eliminating a need for an auxiliary lubrication fluid and an associated lubrication system. Although foil-type bearings are employed in turbine 1600, other bearing types may be used as well.

The outer surface of the turbine shaft 1604, between the rotor 1616 and the outlet end 1605, is cylindrical and is partially surrounded by the upper radial foil bearing 1607. The upper radial foil bearing 1607 extends axially between the outlet end 1605 of the turbine shaft 1604 and the inlet in a direction towards the inlet 1615a. The upper radial foil bearing 1607 is received in an annular groove formed in the inner surface of the turbine case 1601 around the outlet end 1605 of the turbine shaft 1604.

The inlets 1615a and 1615b are axially spaced across the rotor 1616. The rotor 1616 has axially opposed upper and lower impellers, 1617 and 1618, respectively, formed in the wall of the turbine shaft 1604. The inner surface 1609 of the turbine shaft 1604 directly above the rotor 1616 extends axially down beyond the upper inlet 1615a and has a curved surface, which redirects fluid entering the upper inlet 1615a in the downward direction toward the upper impeller 1617. The downwardly directed fluid impinges on the curved upper impeller 1617 and rotates the rotor 1616 and the turbine shaft 1604.

The lower portion of the turbine shaft 1604 includes a chamber 1622 below the rotor 1616 and is defined by a flange 1620 and a cylindrical wall 1626. The flange 1620 of the chamber 1622 protrudes axially upward beyond the lower inlet 1615b and forms a curved surface, which redirects fluid entering the lower inlet 1615b in an upward direction toward the lower impeller 1618. The upwardly directed fluid impinges on the lower impeller 1618 and rotates the rotor and the turbine shaft 1604. An orifice 1624 is formed at the center of the flange 1620.

The pump end of the chamber 1622 has an annular flange 1627 which extends inwardly. The flange 1627 is attached to an annular lower sealing surface 1628 valve plate, which forms a closure member of a lower chamber valve 1654. The lower chamber valve 1654 is formed by the lower sealing surface 1628 and a seal 1629 of a lower valve plate 1631, described in greater detail hereinbelow. The flange 1627 is otherwise fastened to an outer rotor 1630 of a magnetic coupling 1660.

The outer rotor 1630 has, at its upper end, a labyrinth seal 1652 formed in the outer surface of the outer rotor 1630. The labyrinth seal 1652 faces a sealing surface 1653 formed in the turbine case 1601 below the lower radial foil bearing 1608. The magnetic coupling 1660 also includes an inner rotor 1634, which is attached to the shaft 146 of the geothermal fluid pump 110 (not shown in FIG. 16). A canister 1636 is disposed between the inner rotor 1634 and the outer rotor 1630. The canister 1636 is attached to a flange 1637 extending from the turbine case 1601 below the outer rotor 1630. The canister 1636 separates geothermal fluid on the inner rotor 1634 side of the canister 1636 from working fluid on the outer rotor 1630 side of the canister 1636.

The lower valve plate 1631 is mounted to a base of the canister 1636. The lower valve plate 1631 is generally cylindrical and does not rotate with the turbine shaft 1604. The lower chamber valve seal 1629 is disposed on the upper surface of the valve plate 1631 at its outer edge. The lower chamber valve seal 1629 is constructed to seal against the lower sealing surface 1628 of the flange 1627. The lower chamber valve seal 1629 may be constructed from a low friction material that can also withstand high temperatures. One suitable material of the seal includes polyether ether ketone (PEEK). Of course, other suitable seal materials exist and are within the scope of the invention. A lower thrust balance chamber 1656 is formed in the spaces between the lower labyrinth seal 1652 and the lower chamber valve 1654.

At the upper end 1605 of the turbine shaft 1604 an annular flange 1670 extends inwardly from the inner surface of the turbine case 1601 above the upper radial foil bearing 1607. An upper labyrinth seal 1650 is formed along the inner annular surface of the flange 1670. A cylindrical surface 1672 extends axially from an upper edge 1674 of the upper end 1605 of the turbine shaft 1604. The cylindrical surface 1672 is constructed to seal with the labyrinth seal 1650 and to permit the leakage of working fluid past the seal 1650. The inner tapered surface 1610 extends radially inwardly and downwardly toward the upper end of the cylindrical surface 1672, defining a partially enclosed chamber 1676 between the surface 1610, the flange 1670, and the cylindrical surface 1672. During operation of turbine 1600, high pressure working fluid leaks from the upper inlet 1615a past the upper radial foil bearing 1607 to lubricate the bearing 1607, and the working fluid continues axially on through the upper labyrinth seal 1650 into the chamber 1676. Fluid in the chamber 1676 escapes through a gap 1678 formed between the surface 1610 and the cylindrical surface 1672.

Unlike the upper valve chamber 1470 in FIG. 14, working fluid in the chamber 1676 does not hydraulically support the upper end 1605 of the turbine shaft, because fluid pressure is exerted on the fixed flange 1670, rather than the edge 1674 of the turbine shaft 1604.

At startup, due to the weight of the turbine shaft 1604, the lower chamber valve 1654 is closed, thus also sealing the lower thrust chamber 1656. High pressure working fluid entering turbine 1600 through the lower inlet 1615b leaks between the turbine case 1601 and the turbine shaft 1604 and travels downward to lubricate the lower foil bearing 1608. The traveling working fluid then passes through the lower chamber labyrinth seal 1652 and down around the annular outer rotor 1630. The working fluid then fills the lower thrust balance chamber 1656 while the turbine shaft 1604 begins rotating. Eventually, pressure in the lower thrust balance chamber 1656 increases to a level that forces the lower chamber valve 1654 to open, releasing the leaked working fluid into the lower chamber 1622, causing the turbine shaft 1604 to move axially upward to support the weight of the turbine. Working fluid in the chamber 1622 can escape through orifice 1624.

The lower chamber valve 1654 and the lower thrust balance chamber 1656 are constructed to maintain the turbine axially spaced from the plate 1631 and the underside of the flange 1670 so that the turbine shaft 1604 can operate reliably without the use of thrust bearings to axially support the turbine shaft 1604.

### Embodiment 8

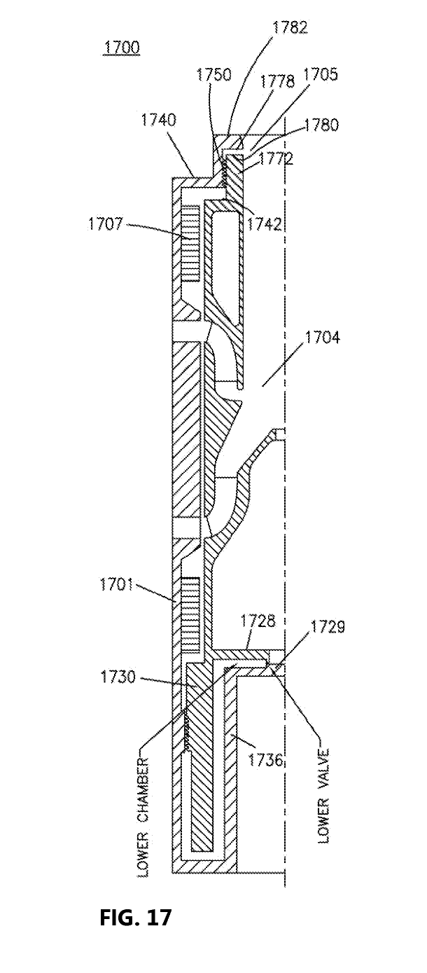

FIG. 17 shows a portion of a turbine 1700, which has an arrangement similar to that of turbine 1600 shown in FIG. 16 and described hereinabove. To simplify the discussion of turbine 1700, attention will be directed to the structural differences between the turbine 1600 and turbine 1700, with other features of turbine 1700 being constructed to operate in a similar manner as turbine 1600.

A turbine shaft 1704 includes an integrally formed outer rotor 1730 and an integrally formed lower sealing surface 1728, which correspond, respectively to the outer rotor 1630 and the lower sealing surface 1628 of turbine 1600. Moreover, turbine 1700 includes a canister 1736, which is integrally formed with a turbine case 1701. Integrally formed with the canister 1736 is a sealing surface 1729, which functions in the same manner as the lower chamber valve-seal 1629 of the lower valve plate 1631 of turbine 1600. Thus, a lower chamber valve is formed between the lower sealing surface 1728 and the sealing surface 1729.

At an upper end of the turbine shaft 1704, a shoulder 1740 is formed in the turbine case 1701 and a corresponding notch 1742 is formed in the upper end of the turbine shaft 1704. An upper labyrinth seal 1750 is formed in the inner side of the turbine case 1701 above an upper radial foil bearing 1707. An axially directed cylindrical surface 1772 extends from the upper end 1705 of the turbine shaft 1704. Axial movement of the turbine shaft 1704 is limited in the upward direction by an annular flange 1782 that extends from the turbine case 1701 above the upper edge 1780 of the cylindrical surface 1772.

During operation, fluid leaks through the upper radial foil bearing 1707, travels past the upper labyrinth seal 1750, and discharges in a gap 1778 between the annular flange 1782 and the upper edge 1780 of the cylindrical surface 1772.

### Embodiment 9

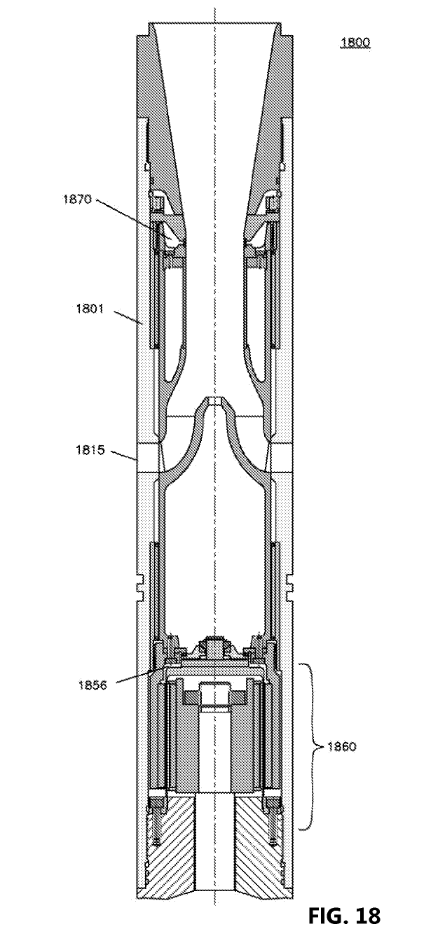

FIG. 18 shows a sectional view of a down-hole turbine 1800 having one radial inlet 1815 and two balance chambers 1856 and 1870 in accordance with an embodiment of the invention. Turbine 1800 is structured similar to turbine 1400, except that turbine 1800 has a turbine casing 1801 with only a single radial inlet and an impeller 1816 with a single stage. All other structural features of turbine 1800, including a magnetic coupling 1860, are constructed substantially the same as those of turbine 1400 and, therefore, a further description of those features is omitted for the sake of brevity. Moreover, the operation of turbine 1800 will not be described in detail as it believed such operational details will be understood by one of ordinary skill in consultation with the description of turbine 1400.

### Embodiment 10

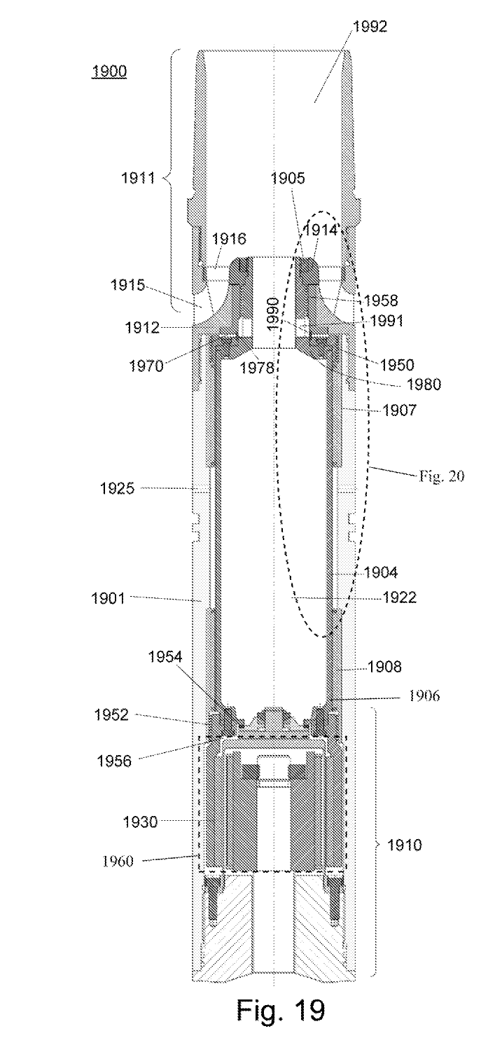

FIG. 19 shows a sectional view of a down-hole turbine 1900 having an axial inlet configuration and two balance chambers 1956 and 1970 in accordance with an embodiment of the invention. A lower portion 1910 of turbine 1900, which includes a magnetic coupling 1960, is structured in substantially the same manner as that for turbine 1400 unless otherwise noted. Turbine 1900 has a turbine shaft 1904 that is attached at its pump end 1906 to an outer rotor 1930 of a magnetic coupling 1960.

However, an upper section 1911 of turbine 1900 is structured differently from turbine 1400. More specifically, turbine 1900 is structured with an axial turbine rather than a radial turbine, as described hereinbelow. At its output end 1905 the turbine shaft 1904 is connected to an axial impeller 1916 having a single stage. The single stage impeller 1916 of turbine 1900 is fed working fluid through an inlet or opening 1915 in a turbine case 1901 of turbine 1900. The working fluid enters the inlet 1915 radially, and the working fluid is redirected axially by curved surface 1912, which is attached to the turbine case 1901. A hub 1914 of the impeller 1916 is attached to the output end 1905 of the turbine shaft 1904. The curved surface 1912 curves radially inwardly and in the output direction and extends to the hub 1914.

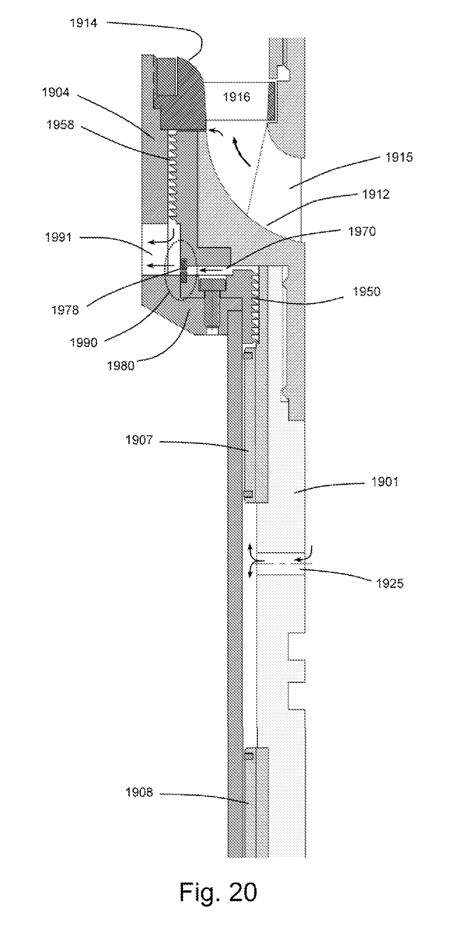

As shown in FIG. 19, and in greater detail in FIG. 20, attached to an inner annular wall of the curved surface 1912 is a first labyrinth seal 1958, which seals with an outer surface of the turbine shaft 1904. Below the lower surface of the first labyrinth seal 1958 there is an upper chamber valve seal 1978 of an upper chamber valve 1990 which seals an upper balance chamber 1970 defined between an annular flange 1980 of the turbine shaft 1904 and a second labyrinth seal 1950, which is formed between the turbine shaft 1904 and an upper radial foil bearing 1907. The upper chamber valve seal 1978 is located radially at a predetermined distance to provide a surface upon which working fluid pressure acts to force the turbine shaft 1904 axially in the downward direction.

At startup, the weight of the turbine shaft 1904 forces the turbine shaft 1904 in the downward direction so that a lower chamber valve 1954 is closed while the upper chamber valve 1990 is open. At startup, a portion of the high pressure working fluid outside the turbine casing 1901 is redirected through one or more radial openings 1925 formed into the turbine casing 1901. This working fluid flows into the annular space between turbine shaft 1904 and turbine casing 1901, and is then split into first and second portions. The first working fluid portion travels axially upward to lubricate the upper radial foil bearing 1907. The working fluid then passes through the second labyrinth seal 1950 and fills the upper thrust balance chamber 1970, described hereinabove, before flowing past the upper chamber valve 1990. The first portion of the working fluid then flows through one or more radial openings 1991 formed in the inner wall of turbine shaft 1904, and into the chamber 1922. The second working fluid portion travels axially downward from the radial openings 1925 to lubricate a lower radial foil bearing 1908. The working fluid then passes through a third labyrinth seal 1952, which is formed between the lower radial foil bearing 1908 and the upper end of outer rotor 1930. The working fluid then fills a lower thrust balance chamber 1956 formed around the outer rotor 1930 between the third labyrinth seal 1952 and the lower chamber valve 1954. When sufficient pressure builds up in the lower thrust balance chamber 1956 to support the turbine shaft 1904, the turbine shaft translates axially upward and the lower chamber valve 1954 opens, permitting the working fluid in the chamber 1956 to escape into chamber 1922.

When the lower chamber valve 1954 opens, it causes the upper chamber valve 1990 to begin closing, while at the same time lifting the hub 1914 off of the curved surface 1912 and the upper edge of the first labyrinth seal 1958. In operation, high pressure working fluid entering the inlet 1915 leaks through the first labyrinth seal 1958 and then flows into the chamber 1922 through one or more radial openings 1991 in the inner wall of turbine shaft 1904. The closing of upper chamber valve 1990 increases the pressure of the working fluid in the upper thrust balance chamber 1970 so as to exert a downward force onto the turbine shaft 1904. The downward force tends to counteract the upward force caused by the fluid pressure in the lower chamber 1956, thereby limiting the axial upward translation of the turbine shaft 1904. Eventually, an equilibrium will be achieved between the upper chamber 1970 and the lower chamber 1956 in which the turbine shaft will be hydraulically balanced.

The invention has been particularly shown and described with respect to exemplary embodiments thereof. However, it will be understood by those skilled in the art that changes in form and details may be made therein without departing from the scope and spirit of the invention.

What is claimed is:

1. A geothermal power system, comprising:
a turbine-generator structured to receive an organic working fluid and to drive an electric generator;
a down-hole heat exchanger structured to transfer heat from an upwardly directed geothermal fluid to the working fluid; and
a turbine-pump assembly comprised of a turbine coupled to a geothermal fluid pump, the turbine-pump assembly removably disposed down-hole in a well, the geothermal fluid pump being in fluid communication with the down-hole heat exchanger and a source of geothermal fluid and the turbine being in fluid communication with the down-hole heat exchanger and the turbine-generator so as to receive the working fluid from the turbine-generator through a conduit system in the well and to return the working fluid to the turbine-generator through the conduit system, wherein the turbine includes:
a turbine casing,
a turbine shaft rotatably supported by the turbine casing and coaxial with the well,
a rotor coupled to the shaft, wherein the turbine rotor is structured to receive the working fluid from the heat exchanger and to redirect the working fluid to flow in opposed axial directions, and
bearings supporting the turbine shaft, the bearings disposed between the shaft and the turbine casing, the bearings lubricated by the working fluid,
wherein at least one circumferential inlet is formed through the turbine casing, the inlet constructed to direct working fluid to the rotor, and
wherein the turbine shaft is constructed to direct the working fluid redirected by the rotor in an outlet direction towards the turbine-generator.

2. The geothermal power system of claim 1, wherein the turbine casing includes two circumferential inlets axially spaced by the rotor.

3. The geothermal power system of claim 1, wherein the bearings include at least one of a thrust bearing and a radial bearing.

4. The geothermal power system of claim 2, wherein the rotor is constructed to redirect at least a portion of the working fluid to minimize a resultant axial thrust load on the thrust bearings.

5. The geothermal power system of claim 1, wherein the working fluid received by the turbine is in a single phase state or a supercritical state.

6. The geothermal power system of claim 1, wherein the working fluid includes at least one of a hydrocarbon alkane or a hydrofluorocarbon refrigerant.

7. The geothermal power system of claim 1, wherein the turbine shaft is constructed to permit working fluid to leak from the inlet in a pathway between the turbine shaft and the turbine casing to the bearings.

8. The geothermal power system of claim 7, wherein the turbine shaft includes a plurality of circumferential labyrinth seals axially spaced by the inlet such that the working fluid is permitted to leak.

9. The geothermal power system of claim 1,
wherein the down-hole heat exchanger includes:
an annular shell surrounding an axial inner conduit, and
a plurality of pipes disposed axially in the annular shell, and
wherein the geothermal fluid flows upward within the plurality of pipes to heat the working fluid flowing downward in the annular shell in a space surrounding the plurality of pipes.

10. An expander pumping unit for a geothermal power system, comprising:
a turbine disposed down-hole in a geothermal well, the turbine constructed to receive a working fluid flowing downward from a terrestrial surface region and expand the working fluid to the terrestrial surface region; and
a geothermal fluid pump operatively coupled to the turbine to pump geothermal fluid upward from a source of geothermal fluid,
wherein the turbine includes:
a turbine casing,
a turbine shaft rotatably coupled to the turbine casing,
bearings between the turbine casing and the turbine shaft for supporting the turbine shaft in the turbine casing, the bearings lubricated by the working fluid,
a turbine rotor coupled to the turbine shaft, and
at least one circumferential inlet formed around the turbine rotor and constructed for delivering the working fluid to the turbine rotor,
wherein the rotor is constructed to redirect the working fluid received from the inlet in at least two opposed axial directions, and
wherein the turbine shaft is constructed to direct the working fluid redirected by the rotor in an outlet direction toward the terrestrial surface region.

11. The expander pumping unit according to claim 10,
wherein the turbine shaft is axially supported by thrust bearings between the turbine shaft and a turbine casing and wherein the rotor is constructed to redirect the working fluid to minimize the resultant axial thrust load on the thrust bearings.

12. The expander pumping unit according to claim 11, wherein the thrust bearings are of a type lubricated by the working fluid.

13. The expander pumping unit according to claim 10, further comprising a magnetic coupling structured to couple the turbine to the geothermal fluid pump, wherein the magnetic coupling includes a turbine magnet and a pump magnet.

14. The expander pumping unit according to claim 13, wherein the coupling includes a non-magnetic canister interposed between the turbine magnet and the pump magnet which separates the geothermal fluid from the working fluid.

15. The expander pumping unit according to claim 10, wherein the turbine shaft is radially supported by foil bearings.

16. The expander pumping unit according to claim 11, wherein the thrust bearings are between the rotor and the geothermal fluid pump.

17. The expander pumping unit according to claim 11, wherein the thrust bearings are on an opposite side of the rotor from the geothermal fluid pump.

18. The expander pumping unit according to claim 10, wherein the turbine shaft is constructed to permit working fluid to leak from the inlet between the turbine shaft and the casing in a pathway to the bearings.

19. The expander pumping unit according to claim 18, wherein the turbine shaft includes a plurality of circumferential labyrinth seals axially spaced by the inlet such that the working fluid is permitted to leak.

20. A turbine for use down-hole in a geothermal well of a geothermal power system, the turbine comprising:
a turbine casing,
a turbine shaft rotatably coupled to the turbine casing,
bearings between the turbine casing and the turbine shaft for supporting the turbine shaft in the turbine casing, the bearings lubricated by an organic working fluid,
a turbine rotor coupled to the turbine shaft, and
at least one circumferential inlet formed around the turbine rotor and constructed for delivering the working fluid to the turbine rotor,
wherein the rotor is constructed to redirect the working fluid received from the inlet in at least two opposed axial directions, and
wherein the turbine shaft is constructed to direct the working fluid redirected by the rotor axially in an outlet direction toward a terrestrial region above the turbine.

21. The turbine according to claim 20, wherein the rotor includes axially opposed impellers to redirect the working fluid in at least two opposite axial directions.

22. A geothermal power system, comprising:
a turbine-generator structured to receive an organic working fluid and to drive an electric generator;
a down-hole heat exchanger structured to transfer heat from an upwardly directed geothermal fluid to the working fluid; and
a turbine-pump assembly comprised of a turbine coupled to a geothermal fluid pump, the turbine-pump assembly removably disposed down-hole in a well, the geothermal fluid pump being in fluid communication with the down-hole heat exchanger and a source of geothermal fluid and the turbine being in fluid communication with the down-hole heat exchanger and the turbine-generator so as to receive the working fluid from the turbine-generator through a conduit system in the well and to return the working fluid to the turbine-generator through the conduit system, wherein the turbine includes:
a turbine casing,
a turbine shaft rotatably supported by the turbine casing and coaxial with the well, and
a rotor coupled to the shaft, wherein the turbine rotor is structured to receive the working fluid from the heat exchanger and to redirect the working fluid to flow in opposed axial directions,
wherein at least one circumferential inlet is formed through the turbine casing, the inlet constructed to direct working fluid to the rotor, and
wherein the turbine shaft is constructed to direct the working fluid redirected by the rotor in an outlet direction towards the turbine-generator.
